(19) United States
(12) Patent Application Publication
(10) Pub. No.: US 2011/0242068 A1
(43) Pub. Date: Oct. 6, 2011

(54) DISPLAY DEVICE AND ELECTRONIC APPLIANCE

(75) Inventor: Keisuke Omoto, Kanagawa (JP)

(73) Assignee: SONY CORPORATION, Tokyo (JP)

(21) Appl. No.: 13/048,556

(22) Filed: Mar. 15, 2011

(30) Foreign Application Priority Data
Mar. 30, 2010 (JP) 2010-079015

(51) Int. Cl. G06F 3/038

(52) U.S. Cl. 345/204

(57) ABSTRACT

A display device includes: a plurality of arranged pixels, each of which includes an electro-optical component, a write-in transistor writing an image signal in a pixel, a maintenance capacity maintaining the image signal written by the write-in transistor, and a driving transistor driving the electro-optical component based on the image signal maintained by the maintenance capacity; wherein the driving transistor has a sandwich gate structure in which a channel region is sandwiched between two gate electrodes, and the electro-optical component is formed so that at least a portion of one of the two gate electrodes and an anode electrode are opposite to each other.

### BACKGROUND OF THE INVENTION

1. Field of Invention

The invention relates to a display device and an electronic appliance, and more particularly to a display device in which pixels including electro-optical components are two-dimensionally (2D) arranged in the form of a matrix and an electronic appliance having the display device.

2. Description of the Related Art

Recently, in the field of display devices that perform image display, plane-type (flat panel type) display devices in which pixels (pixel circuits) are arranged in the form of a matrix have been rapidly spread. As a kind of plane type display device, there is a display device that uses a so-called current driving type electro-optical component, in which luminance is changed according to a current value that flows in the device, as a light-emitting device of a pixel. As a current driving type electro-optical component, an organic electroluminescence (EL) device is known, which has a phenomenon of emitting light when an electric field is applied to an organic thin film using EL that is an organic material.

An organic EL display device that uses organic EL devices as light-emitting devices of pixels has the following characteristics. That is, since the organic EL device can be driven by an applied voltage equal to or lower than 10V, it consumes little power. Since the organic EL device is a self-light emitting device, it has a high visual recognition of an image in comparison to a liquid crystal display, and since it does not require an illumination member such as a backlight or the like, it is easy to make it light-weight and ultra-thin. Also, since the response speed of the organic EL device is very high to the extent of several μs, no afterimage is generated when a moving image is displayed.

In the same manner as a liquid crystal display, an organic EL display device may adopt a simple (passive) matrix type and an active matrix type as its driving type. However, according to the simple matrix type display device, although it has a simple structure, the light-emitting term of the electro-optical components is decreased as the number of scanning lines (that is, the number of pixels) is increased, and thus it is difficult to realize a large-scale high-definition display device.

Because of this, the development of an active matrix type display device in which current flowing through electro-optical components is controlled by active elements installed in pixels such as the electro-optical components, for example, insulated gate field effect transistors, have been actively made. As the insulated gate field effect transistor, generally, a TFT (Thin Film Transistor) is used. According to the active matrix type display device, the electro-optical components continue light emission through a period of one display frame, and thus it is easy to realize a large-scale high-definition display device.

A pixel circuit that includes a current driving type electro-optical component, which is driven by the active matrix type, is provided with a driving circuit for driving the electro-optical component in addition to the electro-optical component. A pixel circuit is known, which is configured to have an organic EL device 21 that is a current driving type electro-optical component, a driving transistor 22 as a driving circuit, a write-in transistor 23, and a maintenance capacity 24 (for example, see JP-A-2008-310127).

JP-A-2008-310127 discloses that when a gate electrode of a driving transistor 22 is in a floating state, a gate potential V_{g} is changed in association with a source potential Vₛ of the driving transistor 22 to perform a so-called bootstrap operation (see Paragraph No. 0071 of JP-A-2008-310127). JP-A-2008-310127 also discloses that even if the I-V characteristic of the organic EL device 21 is time-dependently changed, the gate-source voltage V_{gs} of the driving transistor 22 is maintained constant, and thus light emitting luminance is maintained constant (see Paragraph No. 0093 of JP-A-2008-310127).

### SUMMARY OF THE INVENTION

In the above-described bootstrap operation, the ratio (=ΔV_{g}/ΔVₛ) of a variation ΔV_{g} of the gate potential V_{g} to a variation ΔVₛ of the source potential Vₛ of the driving transistor 22 becomes a bootstrap gain G_{b}. This bootstrap gain G_{b} is determined by a capacitance value of the maintenance capacity 24 and a capacitance value of parasitic capacitance that is parasitic on the gate electrode of the driving transistor 22.

If the parasitic capacitance that is parasitic on the gate electrode of the driving transistor 22, particularly, the capacitance value of the parasitic capacitance between the gate and the source of the driving transistor 22 is large, the bootstrap gain G_{b} is changed from an ideal state (G_{b}=1). Specifically, the bootstrap gain G_{b} deteriorates. In this case, the luminescent state is not maintained with respect to the gate-source voltage V_{gs} of the driving transistor 22 in a state where a difference ΔVₜₕ in a threshold voltage Vₜₕ between pixels is maintained, dispersion in luminance occurs between the pixels (the details thereof will be described later). The dispersion in luminance between pixels is visually recognized as a vertical line, a horizontal line, or luminance non-uniformity. As a result, the uniformity of a screen is damaged.

Accordingly, it is desirable to provide a display device which can improve the bootstrap gain by reducing the capacitance value between the gate and source of the driving transistor and obtain a good-quality display image without damaging the uniformity of the screen, and an electronic appliance having the display device.

According to an embodiment of the invention, there is provided a display device including: a plurality of arranged pixels, each of which includes an electro-optical component, a write-in transistor writing an image signal in a pixel, a maintenance capacity maintaining the image signal written by the write-in transistor, and a driving transistor driving the electro-optical component based on the image signal maintained by the maintenance capacity; wherein the driving transistor has a sandwich gate structure in which a channel region is sandwiched between two gate electrodes, and the electro-optical component is formed so that at least a portion of one of the two gate electrodes and an anode electrode are opposite to each other.

In the driving transistor having the sandwich gate structure, if the anode electrode of the electro-optical component does not exist in a region that is opposite to one of the two gate electrodes, that is, a so-called back gate electrode, the back gate electrode is opposite to the cathode electrode. Accordingly, a parasitic capacitance is formed between the back gate electrode and the cathode electrode. This parasitic capacitance acts in a direction in which the capacitance value of the parasitic capacitance that is parasitic on the gate electrode of the driving transistor is increased. That is, as the anode electrode of the electro-optical component is opposite to at least a portion of the back gate electrode, the parasitic capacitance is formed between the opposite regions of both the electrodes. This parasitic capacitance acts in a direction in which the parasitic capacitance that is parasitic on the gate electrode of the driving transistor, particularly, the capacitance value between the gate and the source of the driving transistor, is reduced. Accordingly, the bootstrap gain can be improved.

According to the embodiment of the invention, since the bootstrap gain is improved by reducing the capacitance value between the gate and the source of the driving transistor, a good-quality display image can be obtained without damaging the uniformity of the screen.

### BRIEF DESCRIPTION OF THE DRAWINGS

FIG. 1 is a system configuration diagram briefly illustrating the configuration of an organic EL display device to which the invention is applied;

FIG. 2 is a circuit diagram illustrating an example of a circuit configuration of a pixel of an organic EL display device to which the invention is applied;

FIG. 3 is a cross-sectional diagram illustrating an example of a cross-sectional structure of a pixel;

FIG. 4 is a timing waveform diagram illustrating a basic circuit operation of an organic EL display device to which the invention is applied;

FIGS. 5A to 5D are diagrams illustrating a (one of) basic circuit operation of an organic EL display device to which the invention is applied;

FIGS. 6A to 6D are diagrams illustrating a (another) basic circuit operation of an organic EL display device to which the invention is applied;

FIG. 7 is a characteristic diagram illustrating the subject that is caused by dispersion of the threshold voltages Vₜₕ of a driving transistor;

FIG. 8 is a characteristic diagram illustrating the subject that is caused by dispersion of the mobility μ of a driving transistor;

FIGS. 9A to 9C are characteristic diagrams illustrating the relationship between the signal voltage V_{sig} of an image signal and the drain-source current I_{ds} of the driving transistor according to the existence/nonexistence of threshold value correction and mobility correction;

FIG. 10 is a timing waveform diagram illustrating the bootstrap operation;

FIG. 11 is a diagram illustrating the bootstrap gain G_{b};

FIG. 12 is a timing waveform diagram illustrating the recurrence of the dispersion of the threshold voltage Vₜₕ;

FIG. 13 is a diagram illustrating a state where an operation point of an organic EL device is shifted when the organic EL device deteriorates;

FIG. 14 is a timing waveform diagram illustrating that the current of a driving transistor is decreased by the high-voltage of an organic EL device;

FIG. 15 is a diagram illustrating the relationship between the gate voltage V_{g} of an N-channel transistor and the drain-source current I_{ds};

FIG. 16 is across-sectional diagram illustrating a pixel structure according to a reference example having a driving transistor of a sandwich gate structure;

FIG. 17 is a circuit diagram illustrating an equivalent circuit of a pixel structure according to the reference example;

FIG. 18 is across-sectional diagram illustrating a pixel structure according to an embodiment having a driving transistor of a sandwich gate structure;

FIG. 19 is a circuit diagram illustrating an equivalent circuit of a pixel structure according to an embodiment of the invention;

FIG. 20 is a perspective diagram illustrating an external appearance of a television set to which the invention is applied;

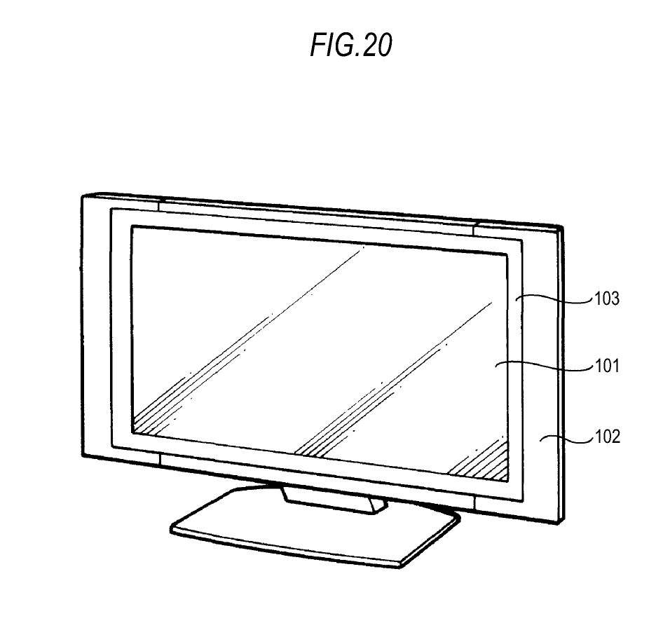

FIGS. 21A and 21B are perspective diagrams illustrating an external appearance of a digital camera to which the invention is applied, in which FIG. 21A is a perspective diagram as seen from the surface side, and FIG. 21B is a perspective diagram as seen from the rear surface side;

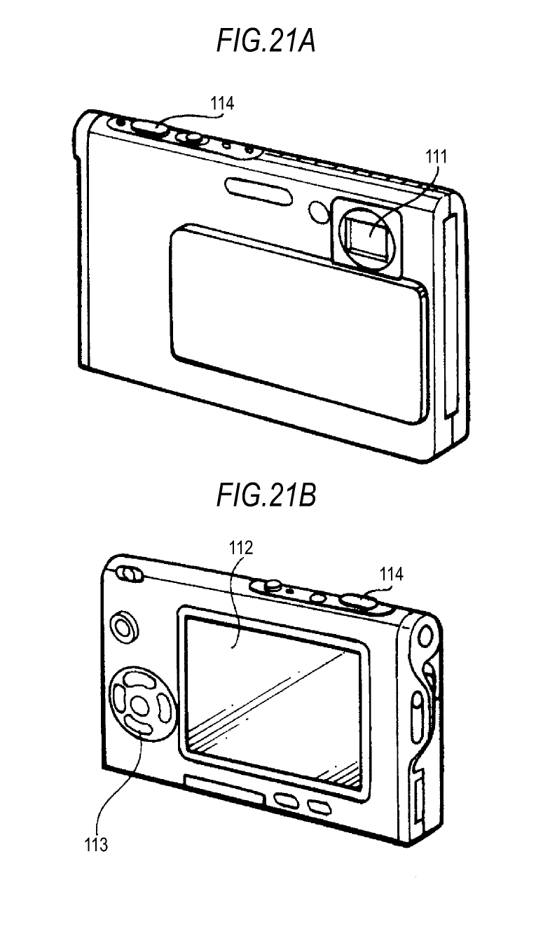

FIG. 22 is a perspective diagram illustrating an external appearance of a notebook type personal computer to which the invention is applied;

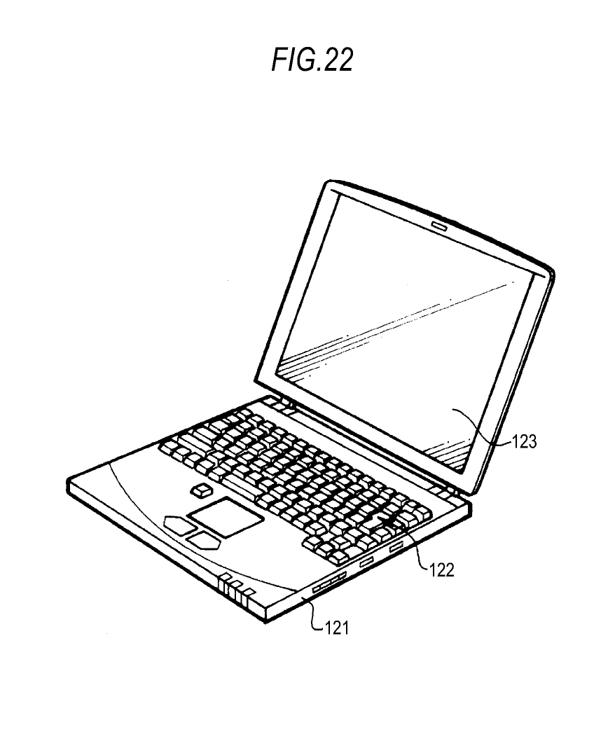

FIG. 23 is a perspective diagram illustrating an external appearance of a video camera to which the invention is applied; and

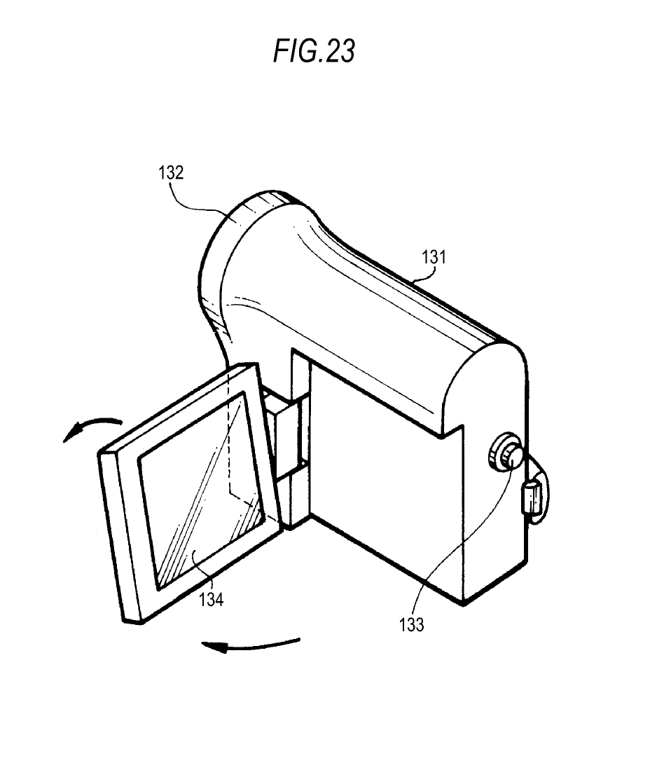

FIGS. 24A to 24G are diagrams illustrating external appearances of a portable phone to which the invention is applied, in which FIG. 24A is a front diagram of a portable phone in an open state, FIG. 24B is a side diagram thereof, FIG. 24C is a front diagram of a portable phone in a closed state, FIG. 24D is a left side diagram thereof, FIG. 24E is a right side diagram thereof, FIG. 24F is a plan diagram thereof, and FIG. 24G is a bottom diagram thereof.

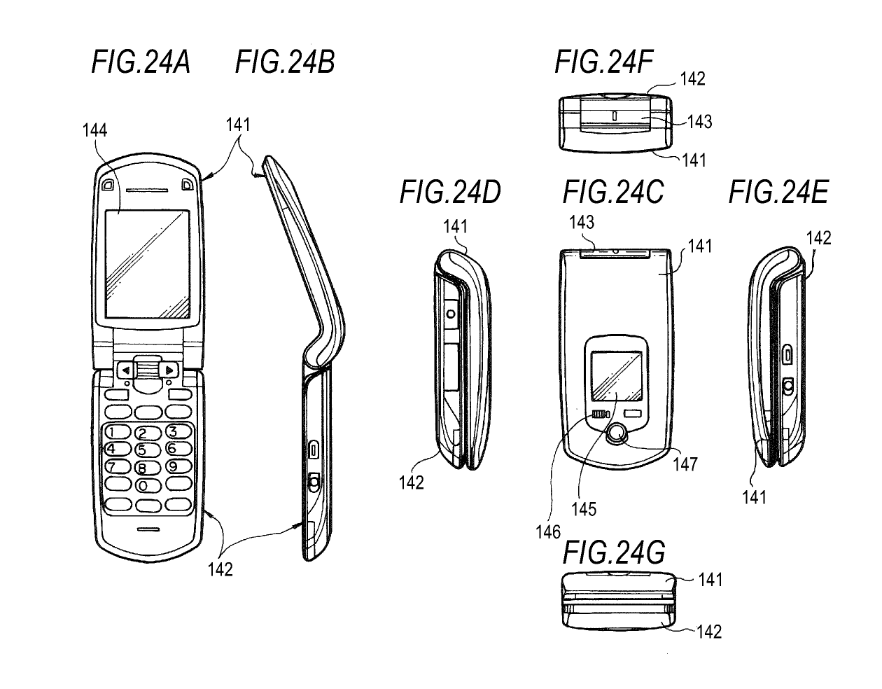

### DESCRIPTION OF THE PREFERRED EMBODIMENTS

Hereinafter, modes for carrying out the invention (hereinafter referred to “embodiments”) will be described with reference to the accompanying drawings. In this case, the explanation will be made in the following order.

1. Organic EL display device to which the invention is applied

1-1. System configuration

1-2. Basic circuit operation

1-3. Regarding bootstrap operation

2. Explanation of organic EL device according to embodiments 3. Modified examples 4. Electronic appliance

### 1. ORGANIC EL DISPLAY DEVICE TO WHICH THE INVENTION IS APPLIED

### 1-1. System Configuration

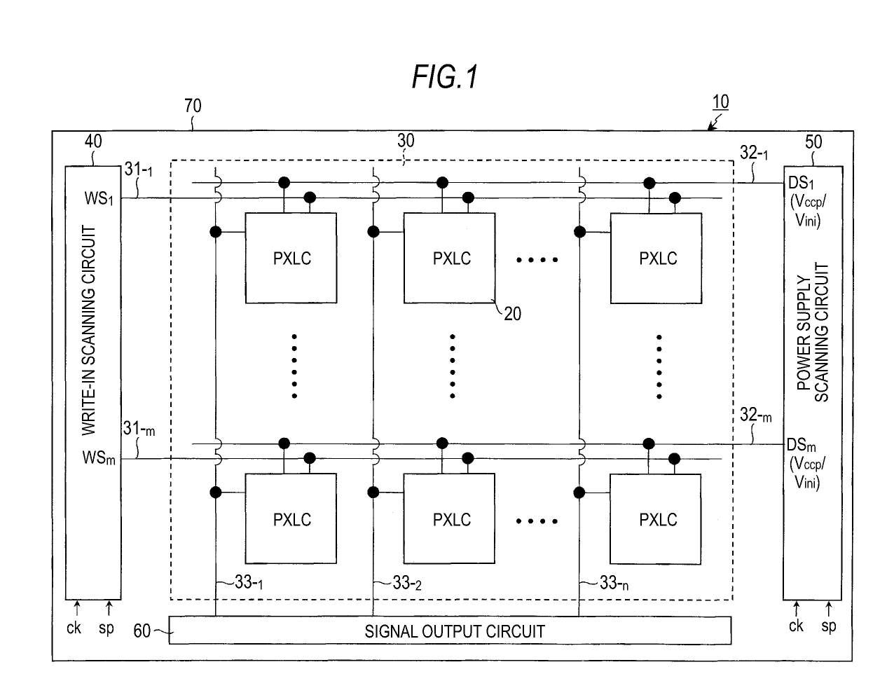

FIG. 1 is a system configuration diagram briefly illustrating the configuration of an active matrix type display device to which the invention is applied.

An active matrix type display device is a display device that controls the current flowing through electro-optical components by active elements installed in pixels such as the electro-optical components, for example, insulated gate field effect transistors. As the insulated gate field effect transistor, generally, a TFT (Thin Film Transistor) is used.

Here, as an example, a current drive type electro-optical component, in which luminance is changed according to a current value flowing through the device, for example, an active matrix type organic EL display device that uses organic EL devices as light-emitting devices of pixels (pixel circuits), will be described.

As illustrated in FIG. 1, an organic EL display device 10 according to this application includes a plurality of pixels 20 including organic EL devices, a pixel array unit 30 in which the pixels 20 are two-dimensionally (2D) arranged in the form of a matrix, and a driving unit arranged in the neighborhood of the pixel array unit 30. The driving unit includes a write-in scanning circuit 40, a power supply scanning circuit 50, and a signal output circuit 60, and drives the respective pixels 20 of the pixel array unit 30.

Here, in the case where the organic EL display device 10 corresponds to a color display, one pixel is composed of a plurality of sub-pixels, and the sub-pixels constitute a pixel 20. More specifically, in a color display device, one pixel is composed of three sub-pixels, that is, a sub-pixel that emits a red light (R), a sub-pixel that emits a green light (G), and a sub-pixel that emits a blue light (B).

However, one pixel is not limited to a combination of sub-pixels for the three primary colors of RGB, and it is also possible to configure one pixel through the addition of sub-pixel(s) for one color or a plurality of colors to the sub-pixels for three primary colors. More specifically, for example, one pixel may be configured by adding a sub-pixel that emits a white light (W) to improve the luminance to the sub-pixels for three primary colors or by adding at least one sub-pixel that emits a complementary color light to extend the color reproduction range to the sub-pixels for three primary colors.

In the pixel array unit 30, with respect to an arrangement of pixels 20 with m rows and n columns, scanning lines 31₋₁ to 31₋ₘ and power supply lines 32₋₁ to 32₋ₙ are wired for each pixel row along the row direction (pixel arrangement direction of a pixel row). Also, signal lines 33₋₁ to 33₋ₙ are wired for each pixel row along the column direction (pixel arrangement direction of a pixel column).

The scanning lines 31₋₁ to 31₋ₘ are respectively connected to output terminals of the rows that correspond to the write-in scanning circuit 40. The power supply lines 32₋₁ to 32₋ₘ are respectively connected to output terminals of the columns that correspond to the power supply scanning circuit 50. The signal lines 33₋₁ to 33₋ₙ are connected to output terminals of the columns that correspond to the signal output circuit 60.

The pixel array unit 30 is typically formed on a transparent insulating substrate such as a glass substrate or the like. Accordingly, the organic EL display device 10 has a plane type (flat type) panel structure. The driving circuit of the respective pixels 20 of the pixel array unit 30 may be formed using amorphous silicon TFTs or low-temperature polysilicon TFTs. In the case of using the low-temperature polysilicon TFTs, as illustrated in FIG. 1, the write-in scanning circuit 40, the power supply scanning circuit 50, and the signal output circuit 60 can also be mounted on the display panel (substrate) 70 that forms the pixel array unit 30.

The write-in scanning circuit 40 includes a shift register that shifts (transmits) a start pulse sp in order in synchronization with a clock pulse ck. In writing an image signal in the respective pixels 20 of the pixel array unit 30, the write-in scanning circuit 40 scans in order (progressively scans) the respective pixels 20 of the pixel array unit 30 in the unit of a row by progressively supplying the write scan signal WS (WS₁ to WSₘ) with respect to the scanning lines 31₋₁ to 31₋ₘ.

The power supply scanning circuit 50 includes a shift register that shifts a start pulse sp in order in synchronization with a clock pulse ck. In synchronization with the progressive scanning by the write-in scanning circuit 40, the power supply scanning circuit 50 supplies the power supply potential DS (DS₁ to DSₘ), which can be switched between a first power supply potential V_{ccp} and a second power supply potential Vᵢₙᵢ that is lower than the first power supply potential V_{ccp}, to the power supply lines 32₋₁ to 32₋ₘ. As described later, by switching V_{ccp}/Vᵢₙᵢ of the power supply potential DS, the control of light emission/non-light emission of the pixels 20 is performed.

The signal output circuit 60 selectively outputs a signal voltage V_{sig} of an image signal according to luminance information that is supplied from a signal supply source (not illustrated) (hereinafter maybe simply referred to as “signal voltage”) and a reference voltage V_{ofs}. Here, the reference voltage V_{ofs} is a voltage that becomes a reference against the signal voltage V_{sig} of the image signal (for example, a voltage that corresponds to the black level of the image signal), and is used to perform correction of the threshold value to be described later.

The signal voltage V_{sig} output from the signal output circuit 60/the reference voltage V_{ofs} is written in the unit of a pixel row that is selected by scanning through the write-in scanning circuit 40, with respect to the respective pixels 20 of the pixel array unit 30 through the signal lines 33₋₁ to 33₋ₙ. That is, the signal output circuit 60 adopts a line-sequential writing driving type that writes the signal voltage V_{sig} in the unit of a row (line).

### (Pixel Circuit)

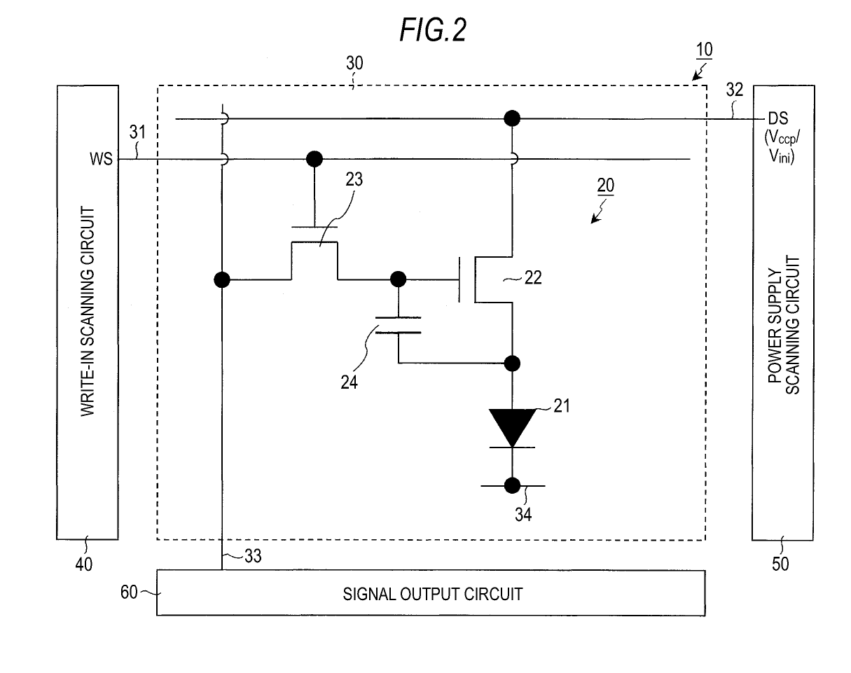

FIG. 2 is a circuit diagram illustrating an example of a circuit configuration of a pixel (pixel circuit) 20.

As illustrated in FIG. 2, the pixel 20 is composed of an organic EL device 21 that is a current drive type electro-optical component, in which luminance is changed according to a current value flowing through the device, and a driving circuit driving the organic EL device 21 by flowing a current to the organic EL device 21. The cathode electrode of the organic EL device 21 is connected to a common power supply line 34 that is commonly wired (so-called solid-wired) with respect to all the pixels 20.

The driving circuit that drives the organic EL device 21 is composed of a driving transistor 22, a write-in transistor 23, and a maintenance capacity 24. As the driving transistor 22 and the write-in transistor 23, N-channel TFTs maybe used. However, a conduction type combination of the driving transistor 22 and the write-in transistor 23 as described herein is merely exemplary, and the driving circuit is not limited to such a combination.

If the N-channel TFTs are used as the driving transistor 22 and the write-in transistor 23, they may be formed using an amorphous silicon (a-Si) process. By using the a-Si process, it becomes possible to provide a substrate for making the TFTs at a low cost, and further to provide the organic EL display device 10 at a low cost. Also, if the driving transistor 22 and the write-in transistor 23 are provided as a combination of the same conduction type, both the transistors 22 and 23 can be made in the same process, and thus this can contribute to the low-cost of the transistors.

One electrode (source/drain electrode) of the driving transistor 22 is connected to the anode electrode of the organic EL device 21, and the other electrode (drain/source electrode) thereof is connected to the power supply line 32 (32₋₁ to 32₋ₘ) .

One electrode (source/drain electrode) of the write-in transistor 23 is connected to the signal line 33 (33₋₁ to 33₋ₙ), and the other electrode (drain/source electrode) thereof is connected to the gate electrode of the driving transistor 22. Also, the gate electrode of the write-in transistor 23 is connected to the scanning line 31 (31₋₁ to 31₋ₘ).

In the driving transistor 22 and the write-in transistor 23, one electrode means a metal wire that is electrically connected to the source/drain region, and the other electrode means a metal wire that is electrically connected to the drain/source region. Also, if one electrode becomes a source electrode by the potential relationship between one electrode and the other electrode, the other electrode becomes a drain electrode, while if one electrode becomes a drain electrode, the other electrode becomes a source electrode.

One electrode of the maintenance capacity 24 is connected to the gate electrode of the driving transistor 22, and the other electrode thereof is connected to the other electrode of the driving transistor 22 and the anode electrode of the organic EL device 21.

In this case, the driving circuit of the organic EL device 21 is not limited to the circuit configuration that is composed of two transistors, that is, the driving transistor 22 and the write-in transistor 23, and one capacitance device, that is, the maintenance capacity 24. For example, as one electrode is connected to the anode electrode of the organic EL device 21 and the other electrode is connected to a fixed potential, it becomes possible to adopt a circuit configuration in which a supplementary capacitance that supplements the capacitance shortfall of the organic EL device 21 is installed if necessary.

In the pixel 20 having the above-described configuration, the write-in transistor 23 is in a conductive state in response to a high (active) write-in scanning signal WS that is applied from the write-in scanning circuit 40 to the gate electrode through the scanning line 31. Accordingly, the write-in transistor 23 samples the signal voltage V_{sig} of the image signal according to the luminance information or the reference voltage V_{ofs}, which is supplied from the signal output circuit 60 through the signal line 33, and writes the sampled voltage in the pixel 20. This written signal voltage V_{sig} or the reference voltage V_{ofs} is applied to the gate electrode of the driving transistor 22 and is maintained in the maintenance capacity 24.

When the potential DS of the power supply line 32 (32₋₁ to 32₋ₘ) reaches the first power supply potential V_{ccp}, one electrode of the driving transistor 22 becomes a drain electrode and the other electrode thereof becomes a source electrode, and thus the driving transistor 22 operates in a saturation region. Accordingly, the driving transistor 22 receives a current supply from the power supply line 32 and current-drives the organic EL device 21 to emit light. More specifically, the driving transistor 22, which operates in a saturation region, supplies a drive current having a current value according to the voltage value of the signal voltage V_{sig} that is maintained in the maintenance capacity 24 to the organic EL device 21, and current-drives the organic EL device 21 to emit light.

Also, when the power supply potential DS is changed from the first power supply potential V_{ccp} to the second power supply potential Vᵢₙᵢ, one electrode of the driving transistor 22 becomes the source electrode and the other electrode thereof becomes the drain electrode, and thus the driving transistor 22 operates as a switching transistor. Accordingly, the driving transistor 22 stops the supply of the drive current to the organic EL device 21 to make the organic EL device 21 in a non-light emission state. That is, the driving transistor 22 also has a function as a transistor that controls light emission/non-light emission of the organic EL device 21.

By the switching operation of the driving transistor 22, the ratio (duty) of a light emission period to a non-light emission period of the organic EL device 21 can be controlled by setting the period in which the organic EL device 21 is in a non-light emission state (non-light emission period). Since afterimage blurring according to the pixel emits light through one display frame period can be reduced by the duty control, the image quality of a moving image becomes more superior.

Of the first and second power supply potentials V_{ccp} and Vᵢₙᵢ that are selectively supplied from the power supply scanning circuit 50 through the power supply line 32, the first power supply potential V_{ccp} is a power supply potential for supplying the drive current for driving the organic EL device 21 to the driving transistor 22. Also, the second power supply potential Vᵢₙᵢ is a power supply potential for applying a reverse bias to the organic EL device 21. The second power supply potential Vᵢₙᵢ is set to a potential that is lower than the reference voltage V_{ofs}, for example, on the assumption that the threshold voltage of the driving transistor 22 is Vₜₕ, a potential that is lower than V_{ofs}−Vₜₕ, and preferably, a potential that is sufficiently lower than V_{ofs}−Vₜₕ.

### (Pixel Structure)

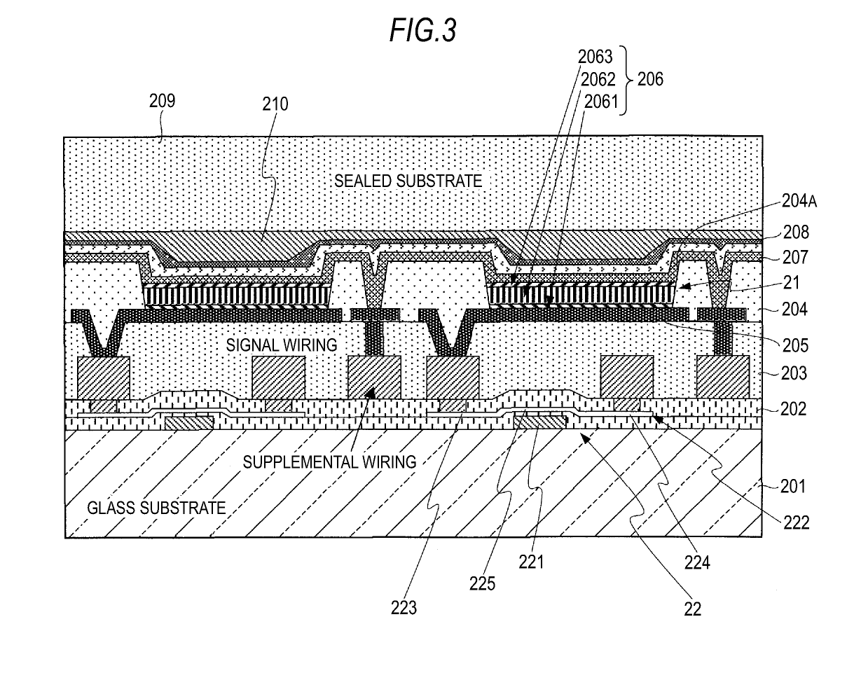

FIG. 3 is a cross-sectional diagram illustrating an example of a cross-sectional structure of a pixel 20. As illustrated in FIG. 3, a driving circuit that includes a driving transistor 22 and the like is formed on a glass substrate 201. Also, the pixel 20 has a configuration in which an insulating film 202, an insulating planarization film 203, and a window insulating film 204 are formed in order on the glass substrate 201, and an organic EL device 21 is installed on a concave portion 204A of the window insulating film 204. Here, among the respective configuration devices of the driving circuit, only the driving transistor 22 is illustrated, but illustration of other configuration devices is omitted.

The organic EL device 21 is composed of an anode electrode 205, an organic layer (electron transport layer, a luminous layer, and a hole transport layer/hole injection layer) 206, and a cathode layer 207. The anode electrode 205 is composed of a metal and the like, which is formed on the bottom portion of the concave portion 204A of the window insulating film 204. The organic layer 206 is formed on the anode electrode 205. The cathode electrode 207 is composed of a transparent conduction layer and the like, which is formed commonly to the whole pixel on the organic layer 206.

In the organic EL device 21, the organic layer 206 is formed on the anode electrode 205 by sequentially depositing a hole transport layer/hole injection layer 2061, a luminous layer 2062, an electron transport layer 2063, and an electron injection layer (not illustrated). Also, as current flows from the driving transistor 22 to the organic layer 206 through the anode electrode 205 under the current driving by the driving transistor 22 of FIG. 2, the luminous layer 2062 emits light when electrons and holes are recombined in the luminous layer 2062 in the organic layer 206.

The driving transistor 22 is composed of a gate electrode 221, source/drain regions 223 and 224 installed on both sides of a semiconductor layer 222, and a channel forming region 225 of a portion that is opposite to the gate electrode 221 of the semiconductor layer 222. The source/drain region 223 is electrically connected to the anode electrode 205 of the organic EL device 21 through contact holes.

Also, as illustrated in FIG. 3, after the organic EL device 21 is formed on the glass substrate 201 in the unit of a pixel via the insulating film 202, the insulating planarization film 203, and the window insulating film 204, a sealing substrate 209 is bonded via a passivation film 208 by an adhesive 210. As the organic EL device 21 is sealed by the sealing substrate 209, the display panel 70 is formed.

### 1-2. Basic Circuit Operation

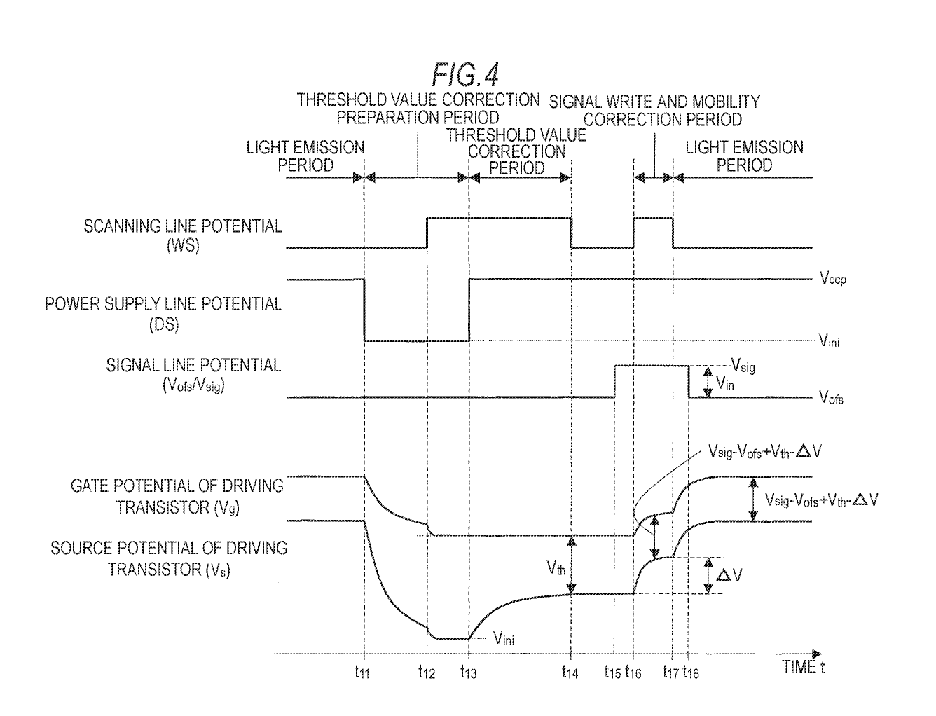

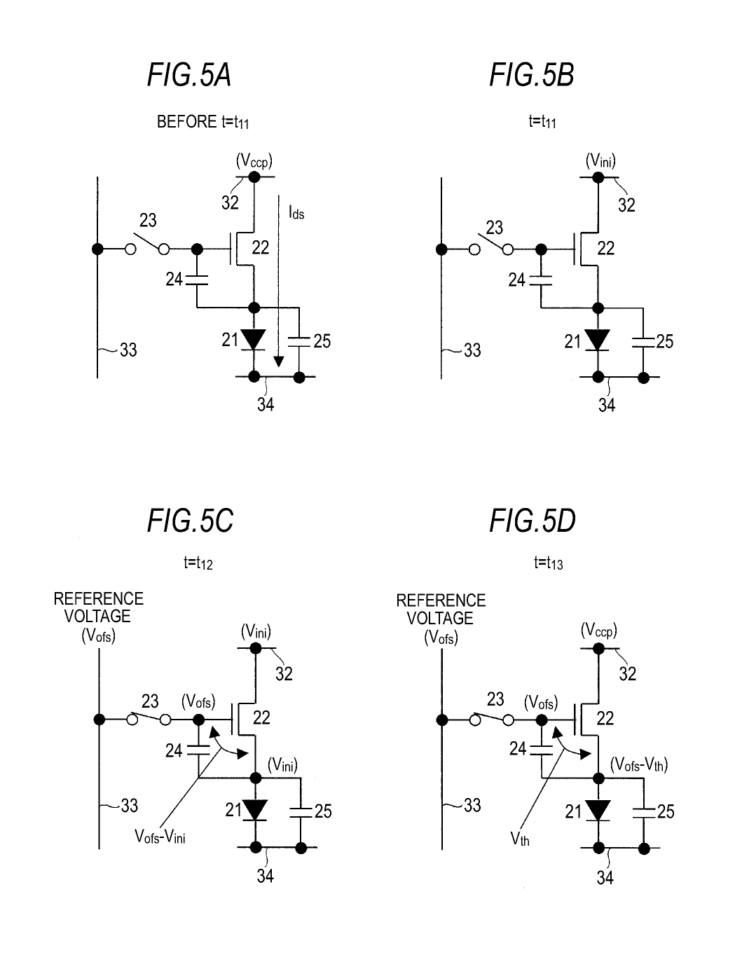

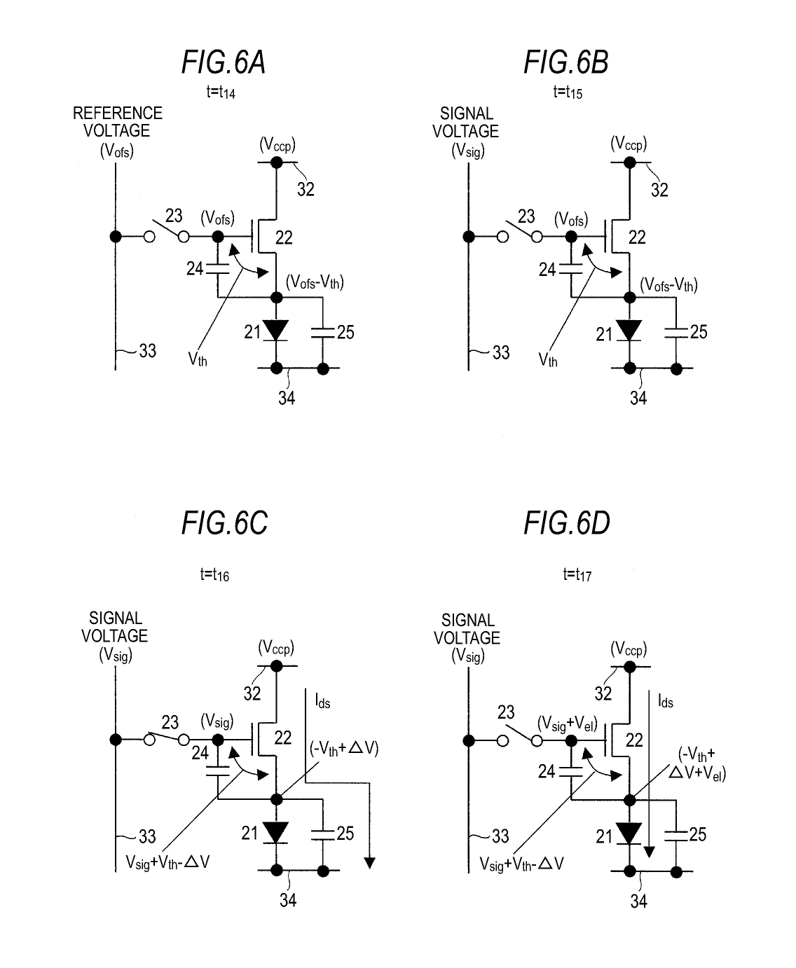

Now, the basic circuit operation of the organic EL display device 10 as configured above will be described using operation diagrams of FIGS. 5A to 5D and 6A to 6D based on the timing waveform diagram of FIG. 4. In the operation diagrams of FIGS. 5A to 5D and 6A to 6D, for the simplicity of the drawings, the write-in transistor 23 is illustrated as a switch symbol. Also, an equivalent capacitance 25 of the organic EL device 21 is also illustrated.

The timing waveform diagram of FIG. 4 illustrates the changes of the potential (write-in scanning signal) WS of the scanning line 31, the potential (power supply potential) DS of the power supply line 32, the potential V_{sig}/V_{ofs} of the signal line 33, the gate potential V_{g}, and the source potential Vₛ of the driving transistor 22.

### (Light Emission Period of Previously Displayed Frame)

In the timing waveform diagram of FIG. 4, before the time t₁₁, there exists the light emission period of the organic EL device 21 in the previously displayed frame. In the light emission period of the previously displayed frame, the potential DS of the power supply line 32 reaches the first power supply potential (hereinafter referred to as “high potential”) V_{ccp}, and the write-in transistor 23 is in a non-conductive state.

In this case, the driving transistor 22 is designed to operate in a saturation region. Accordingly, as illustrated in FIG. 5A, the driving current (drain-source current) I_{ds} according to the gate-source voltage V_{gs} of the driving transistor 22 is supplied from the power supply line 32 to the organic EL device 21 through the driving transistor 22. Accordingly, the organic EL device 21 emits light with luminance according to the current value of the driving current I_{ds}.

### (Threshold Value Correction Preparation Period)

At the time t₁₁, a new display frame (current display frame) of the progressive scan line comes in. Also, as illustrated in FIG. 5B, the potential DS of the power supply line 32 is changed from a high potential V_{ccp} to the second power supply potential (hereinafter described as “low potential”) Vᵢₙᵢ that is sufficiently lower than V_{ofs}−Vₜₕ for the reference voltage V_{ofs}.

Here, it is assumed that the threshold voltage of the organic EL device 21 is Vₜₕₑₗ and the potential (cathode potential) of the common power supply line 34 is V_{cath}. In this case, if it is assumed that the low potential Vᵢₙᵢ is Vᵢₙᵢ<Vₜₕₑₗ+V_{cath}, the source potential Vₛ of the driving transistor 21 becomes almost the same as the low potential Vᵢₙᵢ, and thus the organic EL device 21 is in a reverse bias state to be extinct.

Next, at the time t₁₂, the potential WS of the scanning line 31 is shifted from the low potential side to the high potential side, and as illustrated in FIG. 5C, the write-in transistor 23 is in a conductive state. At this time, since the reference voltage V_{ofs} has been supplied from the signal output circuit 60 to the signal line 33, the gate potential V_{g} of the driving transistor 22 becomes the reference voltage V_{ofs}. Also, the source potential Vₛ of the driving transistor 22 reaches the potential Vᵢₙᵢ that is sufficiently lower than the reference voltage V_{ofs}.

At this time, the gate-source voltage V_{gs} of the driving transistor 22 becomes V_{ofs}−Vᵢₙᵢ. Here, if V_{ofs}−Vᵢₙᵢ is not larger than the threshold voltage Vₜₕ of the driving transistor 22, the threshold value correction process to be described later may not be performed, and thus it is necessary to set the potential relationship in that V_{ofs}−Vᵢₙᵢ becomes V_{ofs}−Vᵢₙᵢ>Vₜₕ.

As described above, the initialization process of fixing the gate potential V_{g} of the driving transistor 22 to the reference voltage V_{ofs} and fixing (deciding) the source potential Vₛ to the low potential Vᵢₙᵢ is a preparation (threshold value correction preparation) process before the threshold value correction process (threshold value correction operation) to be described later is performed. Accordingly, the reference voltage V_{ofs} and the low potential Vᵢₙᵢ become the initialization potentials of the gate potential V_{g} and the source potential Vₛ of the driving transistor 22.

### (Threshold Value Correction Period)

Next, at the time t₁₃, as illustrated in FIG. 5D, if the potential DS of the power supply line 32 is changed from the low potential Vᵢₙᵢ to the high potential V_{ccp}, the threshold value correction process starts in a state where the gate potential V_{g} of the driving transistor 22 is maintained. That is, the source potential Vₛ of the driving transistor 22 starts increasing toward the potential that is obtained by subtracting the threshold voltage Vₜₕ of the driving transistor 22 from the gate potential V_{g}.

Here, for convenience, the process of changing the source potential Vₛ toward the potential that is obtained by subtracting the threshold voltage Vₜₕ of the driving transistor from the initialization potential V_{ofs} based on the initialization potential V_{ofs} of the gate electrode of the driving transistor is called a threshold value correction process. If this threshold value correction process is performed, the gate-source voltage V_{gs} of the driving transistor 22 converges to the threshold voltage Vₜₕ of the driving transistor 22. The voltage that corresponds to the threshold voltage Vₜₕ is maintained in the maintenance capacity 24.

In a period (threshold value correction period) in which the threshold value correction process is performed, in order to make the current flow only to the side of the maintenance capacity 24 but not flow to the side of the organic EL device 21, the potential V_{cath} of the common power supply line 34 is set so that the organic EL device 21 is in a cutoff state.

Next, at the time t₁₄, the potential WS of the scanning line 31 is shifted to the low potential side, and as illustrated in FIG. 6A, the write-in transistor 23 becomes a non-conductive state. At this time, the gate electrode of the driving transistor 22 is electrically cut off from the signal line 33, and thus becomes a floating state. However, since the gate-source voltage V_{gs} becomes equal to the threshold voltage Vₜₕ of the driving transistor 22, the driving transistor 22 is in a cutoff state. Accordingly, the drain-source current I_{ds} does not flow through the driving transistor 22.

### (Signal Write and Mobility Correction Period)

Next, at the time t₁₅, as illustrated in FIG. 6B, the potential of the signal line 33 is changed from the reference voltage V_{ofs} to the signal voltage V_{sig} of the image signal. Then, at the time t₁₆, the potential WS of the scanning line 31 is shifted to the high potential side, and as illustrated in FIG. 6C, the write-in transistor 23 becomes a conductive state, and samples and stores the signal voltage V_{sig} of the image signal in the pixel 20.

As the write-in transistor 23 writes the signal voltage V_{sig}, the gate potential V_{g} of the driving transistor 22 becomes the signal voltage V_{sig}. Also, when the driving transistor 22 is driven by the signal voltage V_{sig} of the image signal, the threshold voltage Vₜₕ of the driving transistor 22 and the voltage that corresponds to the threshold voltage Vₜₕ maintained in the maintenance capacity 24 cancel each other. The principle of threshold value cancellation will be described in detail later.

At this time, the organic EL device 21 is in a cutoff state (in high impedance state). Accordingly, the current (drain-source current I_{ds}) flowing from the power supply line 32 to the driving transistor 22 in accordance with the signal voltage V_{sig} of the image signal flows into the equivalent capacitance 25 of the organic EL device 21, and the charging of the equivalent capacitance 25 starts.

As the equivalent capacitance 25 of the organic EL device 21 is charged, the source potential Vₛ of the driving transistor 22 is increased as time lapses. In this case, the dispersion of the threshold voltage Vₜₕ of the driving transistor 22 for each pixel has already been cancelled, and the drain-source current I_{ds} of the driving transistor 22 depends on the mobility μ of the driving transistor 22. The mobility μ of the driving transistor 22 is the mobility of a semiconductor thin film that forms the channel of the driving transistor 22.

Here, it is assumed that the ratio of the maintenance voltage V_{gs} of the maintenance capacity 24 to the signal voltage V_{sig} of the image signal, that is, the write gain G is 1 (ideal value). As the source potential Vₛ of the driving transistor is increased up to the potential of V_{ofs}−Vₜₕ+ΔV, the gate-source voltage V_{gs} of the driving transistor 22 becomes V_{sig}−V_{ofs}+Vₜₕ−ΔV.

That is, the increment ΔV of the source potential Vₛ of the driving transistor 22 acts to be subtracted from the voltage (V_{sig}−V_{ofs}+Vₜₕ) maintained in the maintenance capacity 24, in other words, acts to perform discharge of the maintenance capacitance 24 to put a negative feedback. Accordingly, the increment ΔV of the source potential Vₛ becomes the feedback amount of the negative feedback.

As described above, by putting a negative feedback on the gate-source voltage V_{gs} with the feedback amount ΔV according to the drain-source current I_{ds} flowing through the driving transistor 22, the dependence on the mobility μ of the drain-source current Ids of the driving transistor 22 can be cancelled. This process of cancelling the dependence is the mobility correction process that corrects the dispersion of the mobility μ of the driving transistor 22 for each pixel.

More specifically, since the drain-source current I_{ds} is increased as the signal amplitude Vᵢₙ(=V_{sig}−V_{ofs}) of the image signal that is written on the gate electrode of the driving transistor 22 becomes high, an absolute value of the feedback amount ΔV of the negative feedback is also increased. Accordingly, the mobility correction process according to the luminance level is performed.

Also, in the case where the signal amplitude Vᵢₙ of the image signal is constant, the absolute value of the feedback amount ΔV of the negative feedback becomes large as the mobility μ of the driving transistor 22 is increased, and thus the dispersion of the mobility μ for each pixel can be removed. Accordingly, the feedback amount ΔV of the negative feedback may be the correction amount of mobility correction. The details of the principle of the mobility correction will be described later.

### (Light Emission Period)

Next, at time t₁₇, the potential WS of the scanning line 31 is shifted to the low potential side, as illustrated in FIG. 6D, and thus the write-in transistor 23 becomes in a non-conductive state. Accordingly, the gate electrode of the driving transistor 22 is electrically cut off from the signal line 33, and thus is in a floating state.

Here, when the gate electrode of the driving transistor 22 is in a floating state, the gate potential V_{g} is also changed in association with the change of the source potential Vₛ of the driving transistor 22 since the maintenance capacity 24 is connected between the gate and source of the driving transistor 22. As described above, the change operation of the gate potential V_{g} of the driving transistor 22 in association with the change of the source potential Vₛ is a bootstrap operation by the maintenance capacity 24.

As the gate electrode of the driving transistor 22 is in a floating state and the drain-source current I_{ds} of the driving transistor 22 flows to the organic EL device 21, the anode potential of the organic EL device 21 is increased according to the corresponding current I_{ds}.

Also, if the anode potential of the organic EL device 21 exceeds Vₜₕₑₗ+V_{cath}, a driving current flows to the organic EL device 21, and thus the light emission of the organic EL device 21 starts. Also, the increase of the anode potential of the organic EL device 21 corresponds to the increase of the source potential Vₛ of the driving transistor 22. If the source voltage of the driving transistor 22 is increased, the gate potential V_{g} of the driving transistor 22 is also increased in association by the bootstrap operation of the maintenance capacity 24.

In this case, if it is assumed that the bootstrap gain is 1 (ideal value), the increase amount of the gate potential V_{g} becomes equal to the increase amount of the source potential Vₛ. Accordingly, during the light emission period, the gate-source voltage V_{gs} of the driving transistor 22 is constantly maintained as V_{sig}−V_{ofs}+Vₜₕ−ΔV. Also, at time t₁₈, the potential of the signal line 33 is changed from the signal voltage V_{sig} of the image signal to the reference voltage V_{ofs}.

In a series of circuit operation as described above, respective processing operations of threshold value correction preparation, threshold value correction, write (signal write) of the signal voltage V_{sig}, and mobility correction are performed in one horizontal scanning period (1 H). Also, respective processing operations of signal write and mobility correction are executed in parallel in a time period of t₆ to t₇.

### (Divided Threshold Value Correction)

Here, it is exemplified that the threshold value correction process is executed only once. However, this driving method is merely exemplary, and the invention is not limited to this driving method. For example, it is also possible to adopt a driving method that performs the threshold value correction process plural times in a divided manner through a plurality of horizontal scanning periods that precede the 1 H period, that is, a driving method that performs a so-called divided threshold value correction in addition to the 1H period in which the threshold value correction process is performed together with the mobility correction and the signal write process.

According to the driving method for divided threshold value correction, even if the time that is allocated in one horizontal scanning period is shortened by the multi-pixels according to the high definition, a sufficient time can be secured through a plurality of horizontal scanning period as the threshold value correction period, and thus the threshold value correction process can be accurately performed.

### [Principle of Threshold Value Cancellation]

Here, the principle of threshold value cancellation (that is, threshold value correction) of the driving transistor 22 will now be described. Since the driving transistor 22 is designed to operate in a saturation region, it operates as a constant current source. Accordingly, a constant drain-source current (driving current) I_{ds} that is given by the following equation (1) is supplied from the driving transistor 22 to the organic EL device 21.

I_{ds}=(½)·μ(W/L)Cₒₓ(V_{gs}−Vₜₕ)² (1)

Here, W denotes a channel width of the driving transistor 22, L denotes a channel length, and Cₒₓ denotes a gate capacitance per unit area.

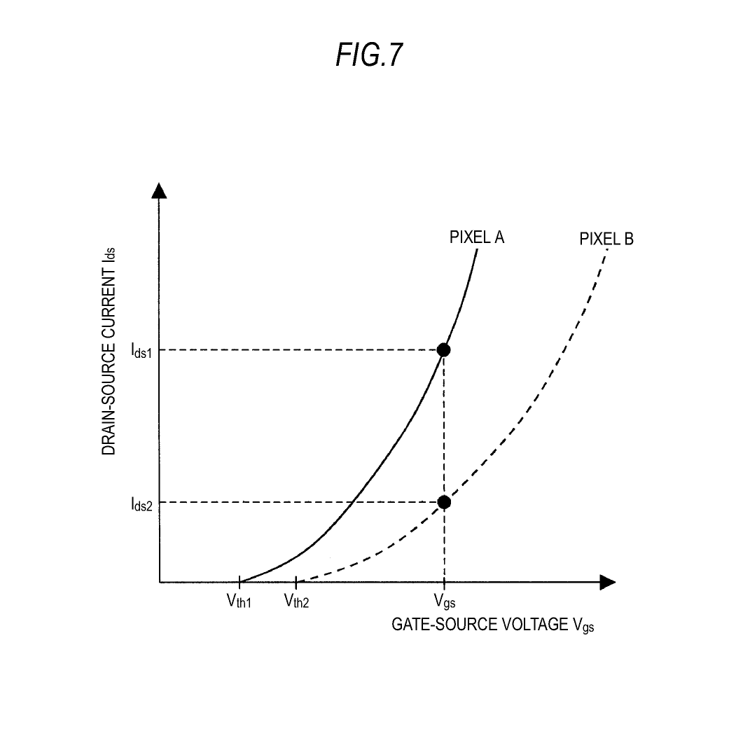

FIG. 7 illustrates the characteristics of the drain-source current I_{ds} versus the gate-source voltage V_{gs} of the driving transistor 22.

As illustrated in this characteristic diagram, if a cancellation process is not performed with respect to the dispersion for each pixel of the threshold voltage Vₜₕ of the driving transistor 22, the drain-source current I_{ds} that corresponds to the gate-source voltage V_{gs} becomes I_{ds1} when the threshold voltage Vₜₕ is Vₜₕ₁.

By contrast, if the threshold voltage Vₜₕ is Vₜₕ₂ (Vₜₕ₂>Vₜₕ₁) in the same manner, the drain-source current I_{ds} that corresponds to the gate-source voltage V_{gs} becomes I_{ds2} (I_{ds2}<I_{ds1}). That is, if the threshold voltage Vₜₕ of the driving transistor 22 is changed, the drain-source current I_{ds} is changed even though the gate-source voltage V_{gs} is constant.

On the other hand, in the pixel (pixel circuit) 20 having the above-described configuration, as described above, the gate-source voltage V_{gs} of the driving transistor 22 during the light emission is V_{sig}−V_{ofs}+Vₜₕ−ΔV. Accordingly, by substituting this in equation (1), the drain-source current I_{ds} is expressed as in the following equation (2).

I_{ds}=(1/2)·μ(W/L)Cₒₓ(V_{sig}−V_{ofs}−ΔV)² (2)

That is, the term of the threshold voltage Vₜₕ of the driving transistor 22 is cancelled, and the drain-source current I_{ds} that is supplied from the driving transistor 22 to the organic EL device 21 is not dependent upon the threshold voltage Vₜₕ of the driving transistor 22. As a result, even if the threshold voltage Vₜₕ of the driving transistor 22 is changed for each pixel due to the dispersion or time-dependent change of the manufacturing process of the driving transistor 22, the drain-source current I_{ds} is not changed, and thus the luminance of the organic EL device 21 can be maintained constant.

### (Principle of Mobility Correction)

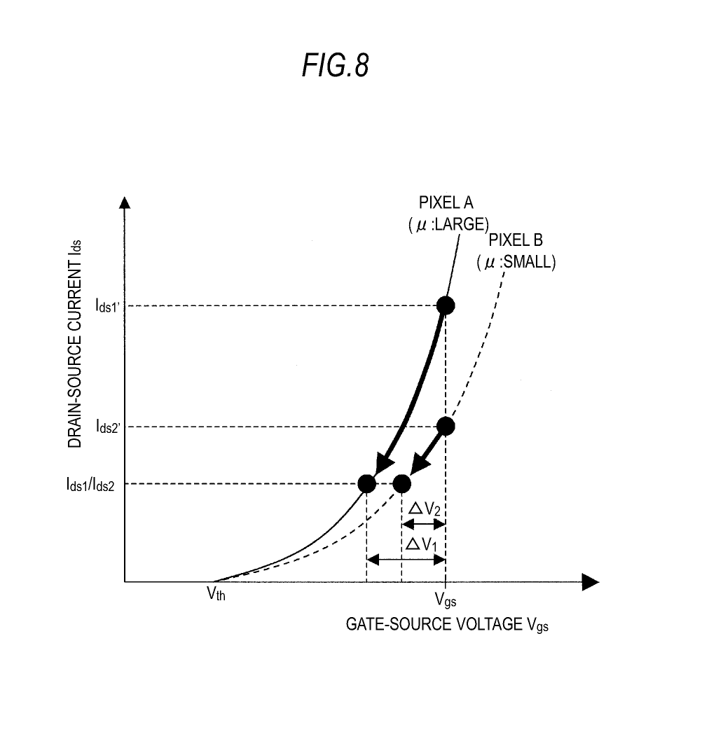

Next, the principle of mobility correction of the driving transistor 22 will be described. FIG. 8 illustrates characteristic curves in a state where a pixel A in which the mobility μ of the driving transistor 22 is relatively large and a pixel B in which the mobilityμ of the driving transistor 22 is relatively small are compared with each other. In the case where the driving transistor 22 is formed of a polysilicon thin film transistor or the like, it is unavoidable that the mobility μ is changed between pixels such as pixel A and pixel B.

A case is considered, in which the signal amplitude Vᵢₙ(=V_{sig}−V_{ofs}) of the same level is written on the gate electrode of the driving transistor 22, for example, in both pixels A and B. In this case, if the correction of the mobility μ is not performed, there is a large difference between the drain-source current I_{ds1}′ that flows to the pixel A having a high mobility μ and the drain-source current I_{ds2}′ that flows to the pixel B having a low mobility μ. As described above, if there is a large difference in drain-source current I_{ds} between the pixels due to the dispersion of the mobility μ for each pixel, the uniformity of the screen is damaged.

Here, as can be known from the transistor characteristic equation (1) as described above, if the mobility μ is high, the drain-source current I_{ds} becomes large. Accordingly, the feedback amount ΔV of the negative feedback becomes large as the mobility μ becomes large. As illustrated in FIG. 8, the feedback amount ΔV₁ of the pixel A having a high mobility μ is larger than the feedback amount ΔV₂ of the pixel B having a low mobility.

Accordingly, by putting a negative feedback on the gate-source voltage V_{gs} with the feedback amount ΔV according to the drain-source current I_{ds} of the driving transistor 22 by the mobility correction process, the negative feedback becomes larger as the mobility μ becomes higher. As a result, the dispersion of the mobility μ for each pixel can be suppressed.

Specifically, if the feedback amount ΔV₁ is corrected in a pixel A having a high mobility μ, the drain-source current I_{ds} greatly descends from I_{ds1}′ to I_{ds1}. On the other hand, since the feedback amount ΔV₂ of the pixel B having a low mobility μ is small, the drain-source current I_{ds} descends from I_{ds2}′ to I_{ds2}, and does not descend any further. As a result, since the drain-source current I_{ds1}′ of the pixel A becomes almost equal to the drain-source current I_{ds2}, the dispersion of the mobility μ for each pixel is corrected.

In summary, if pixels A and B have different mobility μ, the feedback amount ΔV₁ of the pixel A having a high mobility μ becomes larger than the feedback amount ΔV₂ of the pixel B having a low mobility μ. That is, as the mobility μ becomes higher, the feedback amount ΔV of the pixel becomes larger and the reduction amount of the drain-source current I_{ds} becomes larger.

Accordingly, by putting a negative feedback on the gate-source voltage V_{gs} with the feedback amount ΔV according to the drain-source current I_{ds} of the driving transistor 22, the current values of the drain-source currents I_{ds} of the pixels having different mobility μ become uniform. As a result, the dispersion of the mobility μ for each pixel can be corrected. That is, the process of putting a negative feedback on the gate-source voltage V_{gs} of the driving transistor 22 with the feedback amount ΔV according to the current (the drain-source current I_{ds}) that flows to the driving transistor 22 becomes the mobility correction process.

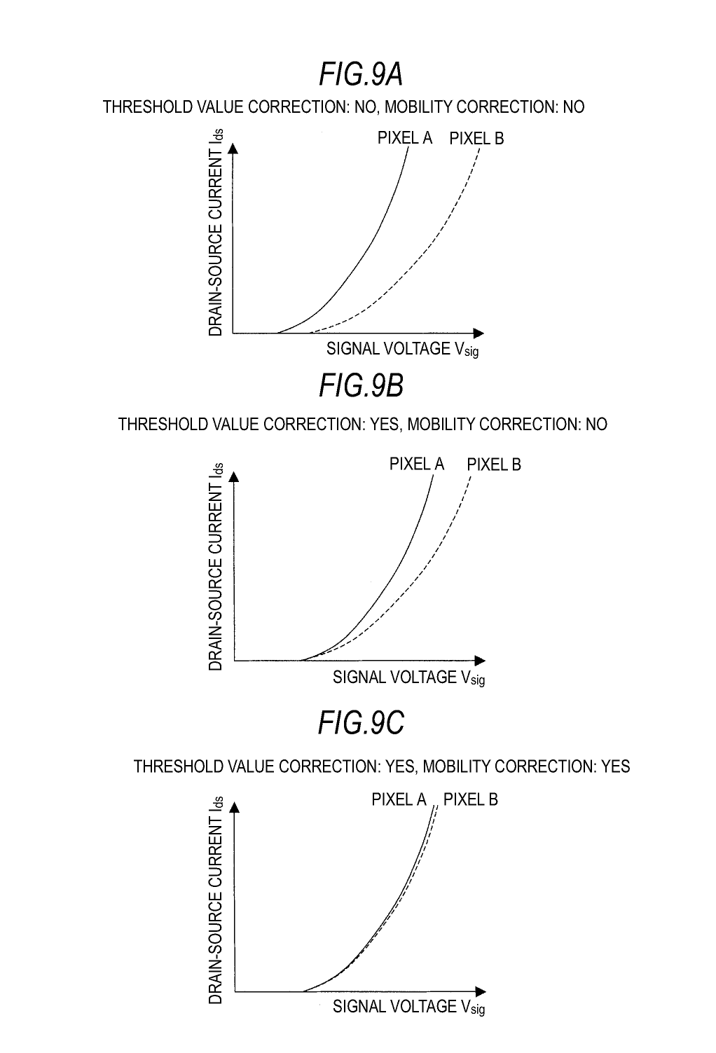

Here, in the pixel (pixel circuit) 20 as illustrated in FIG. 2, the relationship between the signal voltage V_{sig} of an image signal and the drain-source current I_{ds} of the driving transistor 22 according to existence/nonexistence of the threshold value correction and mobility correction will be described using FIGS. 9A to 9C.

FIG. 9A shows a case where neither the threshold value correction nor the mobility correction is performed, FIG. 9B shows a case where the mobility correction is not performed, but the threshold value correction is performed, and FIG. 9C shows a case where both the threshold value correction and the mobility correction are performed. In the case where neither the threshold value correction nor the mobility correction is performed as shown in FIG. 9A, a great difference in drain-source current I_{ds} occurs between the pixels A and B due to the dispersion of the threshold voltage Vₜₕ and the mobility μ between the pixels A and B.

In the case where only the threshold value correction is performed as shown in FIG. 9B, the dispersion of the drain-source current I_{ds} can be somewhat reduced, but there remains a difference in drain-source current I_{ds} between the pixels A and B due to the dispersion of the mobility μ between the pixels A and B. Also, in the case where both the threshold value correction and the mobility correction are performed as shown in FIG. 9C, the difference in drain-source current I_{ds} between the pixels A and B due to the dispersion of the threshold voltage Vₜₕ and the mobility μ between the pixels A and B can be almost eliminated. Accordingly, the luminance dispersion of the organic EL device 21 does not occur in any grayscale, and thus a good quality display image can be obtained.

Also, since the pixel 20 illustrated in FIG. 2 has a function of a bootstrap operation by the above-described maintenance capacity 24 in addition to the function of the threshold value correction and the mobility correction, the following effects can be obtained.

That is, even if the source potential Vs of the driving transistor 22 is changed according to the time-dependent change of the I-V characteristics of the organic EL device 21, the gate-source potential V_{gs} of the driving transistor 22 can be maintained constant by the bootstrap operation through the maintenance capacity 24. Accordingly, the current that flows to the organic EL device 21 is not changed but is maintained constant. As a result, the luminance of the organic EL device is maintained constant, and thus even if the I-V characteristic of the organic EL device 21 is time-dependently changed, an image display accompanying no luminance deterioration ca be realized.

### 1-3. Regarding Bootstrap Operation

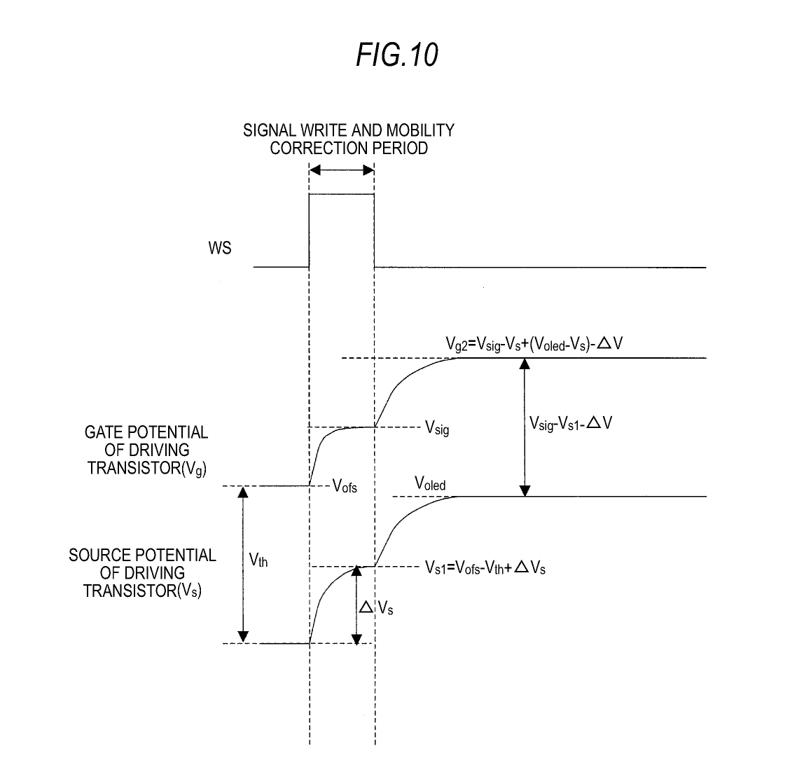

Here, the above-described bootstrap operation will be described in detail using the timing waveform diagram of FIG. 10.

As can be known from the circuit operation as described above, at a time when the signal write and mobility correction period is ended, the signal voltage V_{sig} of the image signal is written on the gate electrode of the driving transistor 22. In this case, the source potential Vₛ of the driving transistor 22 reaches the potential Vₛ₁(=V_{ofs}−Vₜₕ+ΔVₛ) that has ascended as high as the increment ΔVₛ of potential according to the mobility μ from the time when the threshold value correction process is completed.

Here, if the write-in transistor 23 is in a non-conductive state, the gate-source voltage V_{gs} of the driving transistor 22 is maintained by the maintenance capacity 24, and thus the source potential Vₛ ascends up to the potential V_{oled} according to the current I_{ds} that flows to the driving transistor 22. The increment amount at this time is ideally equal to the increment amount V_{oled}−Vₛ₁ of the source potential Vₛ. However, in the case where parasitic capacitance exists in the driving transistor 22 and the write-in transistor 23, the increment amount becomes smaller than the increment amount of the source potential Vₛ.

### (Regarding Bootstrap Gain G_{b})

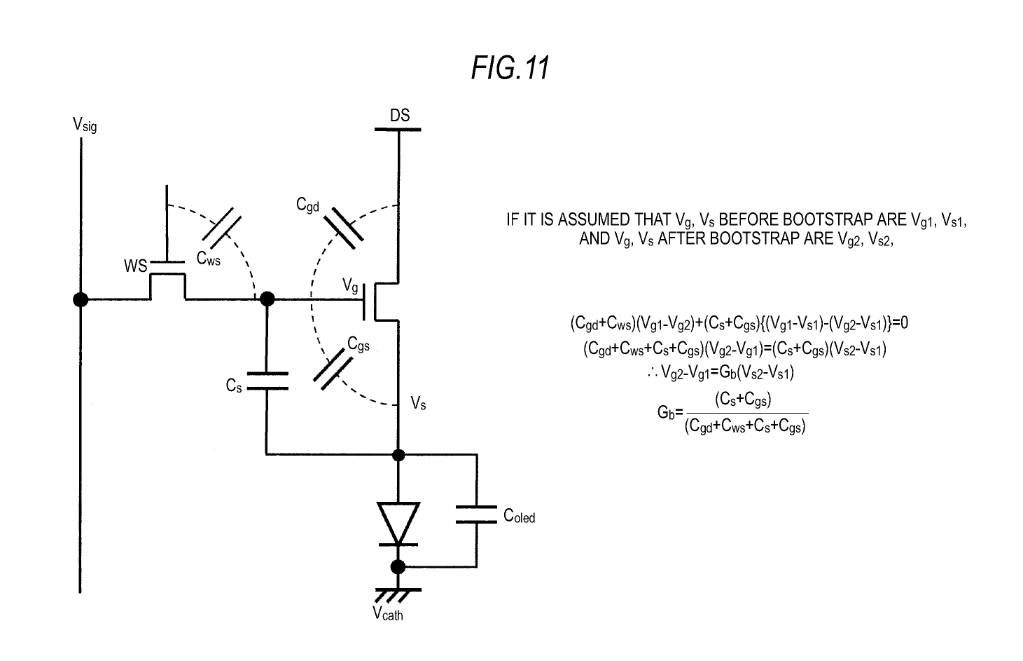

As illustrated in FIG. 11, parasitic capacitances C_{gs}, C_{gd}, and C_{ws} exist in the driving transistor 22 and the write-in transistor 23. The parasitic capacitance C_{gs} is a parasitic capacitance between the gate and source of the driving transistor 22, and the parasitic capacitance C_{gd} is a parasitic capacitance between the gate and drain of the driving transistor 22. The parasitic capacitance C_{ws} is a parasitic capacitance between the gate and drain of the write-in transistor 23.

Here, it is assumed that the gate potential V_{g} and the source potential Vₛ before the bootstrap operation of the driving transistor 22 are V_{g1} and Vₛ₁, respectively, and the gate potential V_{g} and the source potential Vₛ after the bootstrap operation are V_{g2} and Vₛ₂, respectively.

Now, if it is assumed that the source potential Vₛ of the driving transistor 22 has ascended from the potential Vₛ₁ to the potential Vₛ₂, the gate potential V_{g} ascends only up to (Cₛ+C_{gs})/(Cₛ+C_{gs}+C_{gd}+C_{ws})×(Vₛ₂−Vₛ₁). The coefficient at this time, that is, (Cₛ+C_{gs})/(Cₛ+C_{gs}+C_{gd}+C_{ws}), becomes the bootstrap gain G_{b}, and this bootstrap gain G_{b} should be equal to or less than 1. Accordingly, the increment amount ΔVₛ of the gate potential V_{g} becomes smaller than the increment amount ΔV_{g} of the source potential Vₛ.

As described above, in the case where the parasitic capacitance exists in the driving transistor 22 and the write-in transistor 23, the increment amount ΔV_{g} of the gate potential V_{g} becomes smaller than the increment amount ΔVₛ of the source potential Vₛ. As a result, by the bootstrap operation, the gate-source voltage V_{gs} of the driving transistor 22 becomes lower than the gate-source voltage V_{gs} at a time when the mobility correction process is completed. Accordingly, in the case where the parasitic capacitance that is parasitic on the gate electrode of the driving transistor 22 is high and the bootstrap gain G_{b} is low, a desired luminance may not be obtained.

### (Regarding Reoccurrence of Dispersion of Threshold Voltage Vₜₕ)

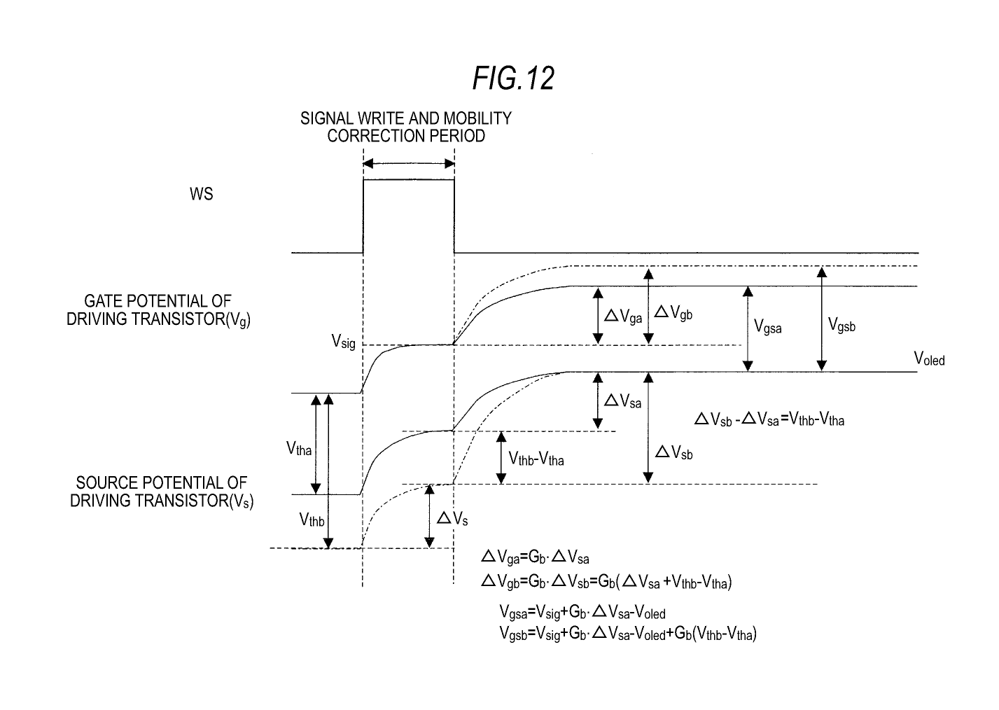

Also, as illustrated in FIG. 12, it is considered that the driving transistor 22 has different threshold voltages Vₜₕₐ and V_{thb}. After completion of the threshold value correction operation, the difference in gate-source voltage V_{gs} between a transistor having the threshold voltage Vₜₕₐ and a transistor having the threshold voltage V_{thb} becomes V_{thb}−Vₜₕₐ. Even in the mobility correction operation, the increment amount ΔVₛ of the source potential Vₛ is not dependent upon the threshold voltage Vₜₕ, and thus the different in the gate-source voltage V_{gs} is maintained as V_{thb}−Vₜₕₐ.

In the case of the bootstrap operation, the source voltage Vₛ ascends up to the voltage V_{oled} that is determined by the current I_{ds} of the driving transistor 22, and thus the increment amounts ΔVₛₐ and ΔV_{sb} of the source potential Vₛ differ from each other to the extent of the difference V_{thb}−Vₜₕₐ of the threshold voltage Vₜₕ. In this case, the increment amount ΔV_{g} of the gate potential V_{g} is determined by the increment amount ΔVₛ of the source potential Vₛ.

Accordingly, as illustrated in FIG. 12, the difference in gate-source voltage V_{gs} after the bootstrap operation becomes (Cₛ+C_{gs})/(Cₛ+C_{gs}+C_{gd}+C_{ws})×(V_{thb}−Vₜₕₐ), which is decreased even after the threshold value correction. Accordingly, although the threshold value correction process has been performed, the dispersion of the threshold voltage Vₜₕ occurs. If the parasitic capacitance is high, the change amount becomes large, and this causes the luminance non-uniformity.

### (Regarding High Voltage of Voltage V_{oled} of Organic EL Device 21)

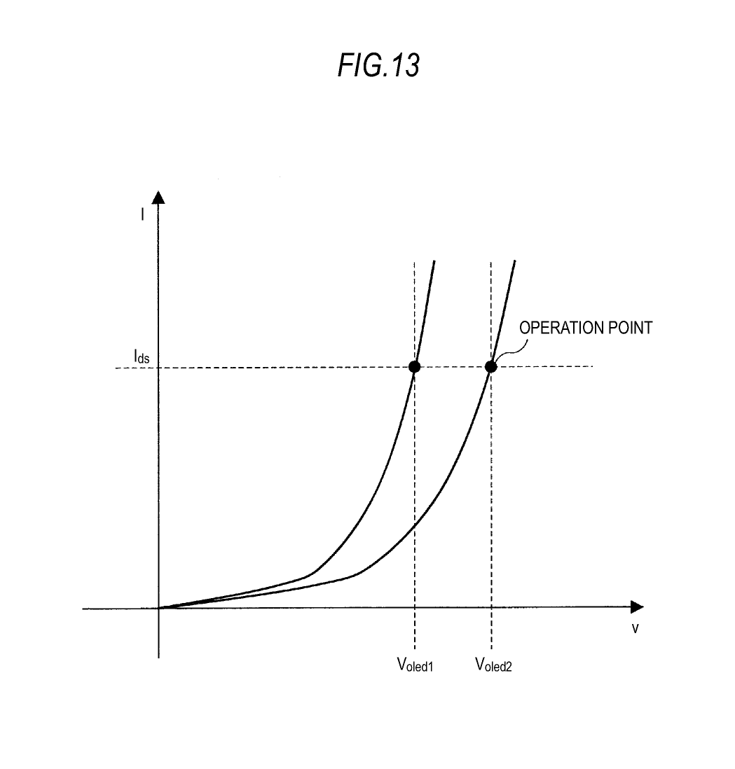

In the case where the organic EL device 21 deteriorates, as illustrated in FIG. 13, the operation point of the organic El device 21 is shifted from the voltage V_{oled1} to the voltage V_{oled2}. That is, the operation point becomes high voltage. Here, it is considered that the voltage V_{oled} of the organic El device 21 becomes high.

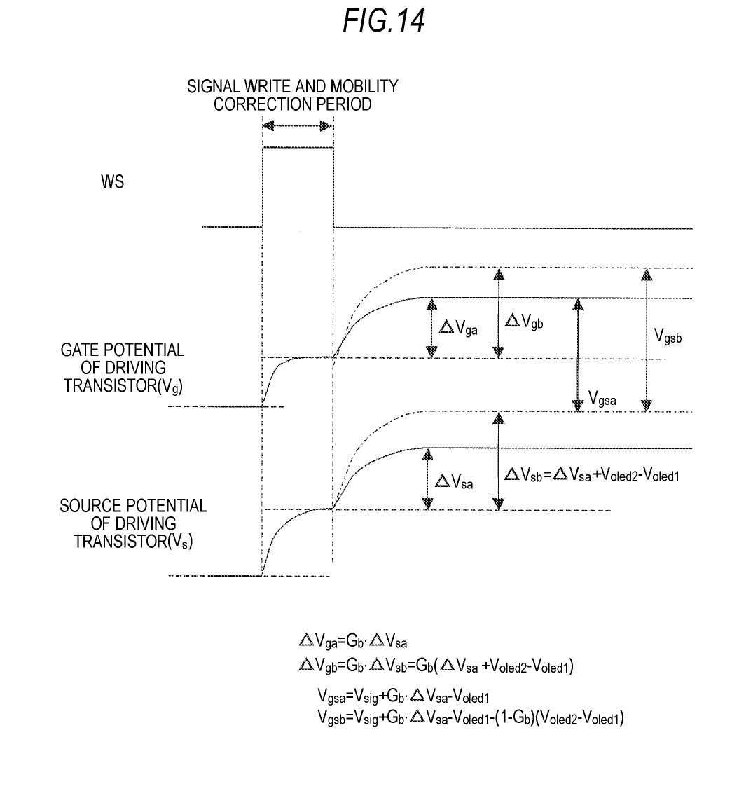

In a pixel where the organic EL device 21 does not deteriorate, the increment amount of the source potential Vₛ during the bootstrap operation is ΔVₛₐ. By contrast, in a pixel where the organic EL device 21 deteriorates, the increment amount ΔV_{sb} of the source potential Vₛ becomes ΔVₛₐ+V_{oled2}−V_{oled1}. Accordingly, the increment amount ΔV_{g} of the gate potential V_{g} is as illustrated in FIG. 14, and the gate-source voltage V_{gs} of the driving transistor 22 is lowered to the extent of (Cₛ+C_{gs})/(Cₛ+C_{gs}+C_{gd}+C_{ws})×(V_{oled2}−V_{oled1}). As a result, if the parasitic capacitance is high, the decrement amount of the gate-source voltage V_{gs} becomes large. That is, the current I_{ds} of the driving transistor 22 deteriorates to cause burn-in.

### (Gate Structure of MOS Transistor)

As a gate structure of a MOS transistor, a top gate structure, a bottom gate structure, and a sandwich gate structure have been widely used. The top gate structure is a structure in which the gate electrode is arranged on an opposite side to the substrate with respect to the channel region. The bottom gate structure is a structure in which the gate electrode is arranged on the substrate side with respect to the channel region. The sandwich gate structure is a structure in which the channel region is sandwiched between two gate electrodes.

In the sandwich gate structure, the second gate electrode is called a back gate electrode. This back gate electrode may function as a shielding member for shielding measures. The transistor of the sandwich gate structure has the advantage in that its characteristic can be improved in comparison to the transistor of the bottom gate structure or the like.

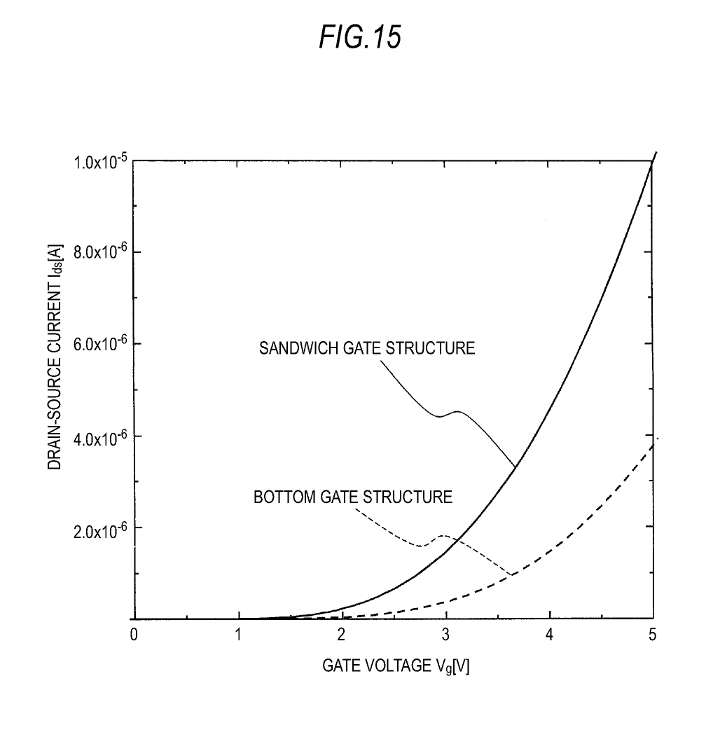

FIG. 15 is a diagram illustrating the relationship, for example, between the gate voltage V_{g} of an N-channel transistor and the drain-source current I_{ds}. In FIG. 15, a solid line represents the characteristic in the case of the sandwich gate structure, and a dashed line represents the characteristic in the case of the bottom gate structure. As can be understood from the drawing, the transistor side of the sandwich gate structure has a more superior characteristic than the transistor of the bottom gate structure.

Also, by using the N-channel transistor of the sandwich structure as the driving transistor 22, the improvement of the characteristic of the driving transistor 22 can be sought. The improvement of the characteristic of the driving transistor 22 means the increase of a driving capability of the driving transistor 22. If the driving capability of the driving transistor 22 is increased, the luminance can be increased.

### (Pixel Structure According to a Reference Example)

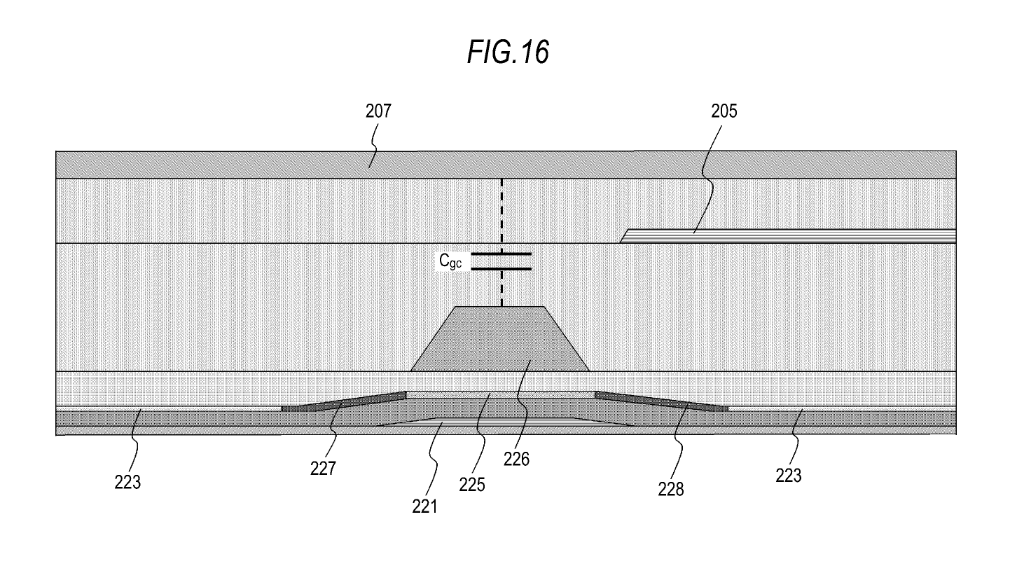

Here, a general pixel structure in the case of using the transistor of the sandwich gate structure as the driving transistor 22 will be described as a reference example using FIG. 16. FIG. 16 is a cross-sectional diagram illustrating a pixel structure according to a reference example having a driving transistor 22 of a sandwich gate structure. In the drawing, same reference numerals are used for the equivalent portions to those in FIG. 3.

The driving transistor 22 has a sandwich gate structure in which the first gate electrode 221 is arranged on the substrate side with respect to the channel region (channel forming region) 225, and the second gate electrode 226 is arranged on the opposite side as the back gate electrode. Also, the driving transistor 22 adopts an LDD structure in which low-density impurity regions, that is, LDD (Lightly Doped Drain) regions 237 and 229, are provided between the channel region 225 and the source/drain regions 223 and 224.

On the other hand, in the organic EL device 21, as described above, the cathode electrode 207 is commonly wired with respect to all the pixels 20, and the anode electrode 205 is arranged to avoid an upper side of the back gate electrode 226 of the driving transistor 22. That is, the anode electrode 205 does not exist in a region opposite to the back gate electrode 226. In this case, the back gate electrode 226 is opposite to the cathode electrode 205 via an insulating layer.

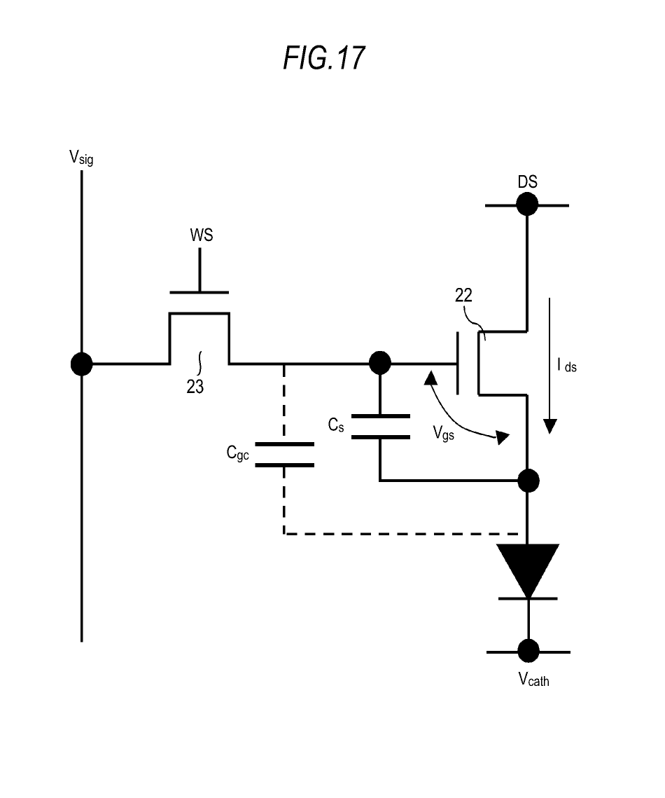

As described above, if the back gate electrode 226 is opposite to the cathode electrode 205, a parasitic capacitance C_{gc} is formed between the electrodes 226 and 205 between which the insulating layer is interposed as a dielectric material. This parasitic capacitance C_{gc} becomes the capacitance component interposed between the gate electrode of the driving transistor 22 and the cathode electrode of the organic EL device 21 as illustrated as the equivalent circuit in FIG. 17. In this case, the bootstrap gain G_{b} is given by the following equation (3).

G_{b}=(Cₛ+C_{gs})/(Cₛ+C_{gs}+C_{gd}+C_{ws}C_{gc}) (3)

As can be understood from the equation (3), if the parasitic capacitance C_{gc} is formed between the back gate electrode 226 and the cathode electrode 205, the parasitic capacitance C_{gs} acts in a direction in which the parasitic capacitance that is parasitic on the gate electrode of the driving transistor 22_{A} is increased, and thus the bootstrap gain G_{b} deteriorates. Accordingly, as described above, since the light emission state may not be maintained in a state where the difference ΔVₜₕ of the threshold voltage Vₜₕ is maintained between pixels with respect to the gate-source voltage V_{gs} of the driving transistor 22, dispersion of luminance occurs between the pixels.

### 2. EXPLANATION OF ORGANIC EL DEVICE ACCORDING TO EMBODIMENTS

The organic EL device according to the embodiment is based on the system configuration as illustrated in FIG. 1, and in the corresponding system configuration, the structure of the driving transistor 22 constituting a pixel is characterized. Hereinafter, the detailed structure of the driving transistor 22 will be described.

In the pixel structure according to the embodiment, the driving transistor 22 is a transistor of a sandwich gate structure in which the channel region (channel forming region) is sandwiched between the two gate electrodes. Preferably, the driving transistor 22 adopts an LDD structure in which low-density impurity regions having a density that is lower than that of the source/drain regions, that is, LDD regions, are installed between the channel region and the source/drain regions, so that high electric field is not concentrated onto the regions.

With respect to the driving transistor 22 of the sandwich gate structure, the anode electrode of the electro-optical component is formed to be opposite to at least a portion of one of the two gate electrodes, that is, a so-called back gate electrode. As the anode electrode of the electro-optical component is opposite to at least a portion of the back gate electrode, a parasitic capacitance is formed between the opposite regions of the electrodes between which the insulating layer is interposed as a dielectric material. This parasitic capacitance acts in a direction in which the parasitic capacitance that is parasitic on the gate electrode of the driving transistor 22, that is, the capacitance value between the gate and source of the driving transistor 22, is reduced.

As described above, by forming the anode electrode of the electro-optical component so that the anode electrode is opposite to at least a portion of the back gate electrode, the capacitance value between the gate and source of the driving transistor 22 can be reduced. Accordingly, the bootstrap gain can be improved, and thus a good-quality display image can be obtained without damaging the uniformity of the screen.

### EXAMPLES

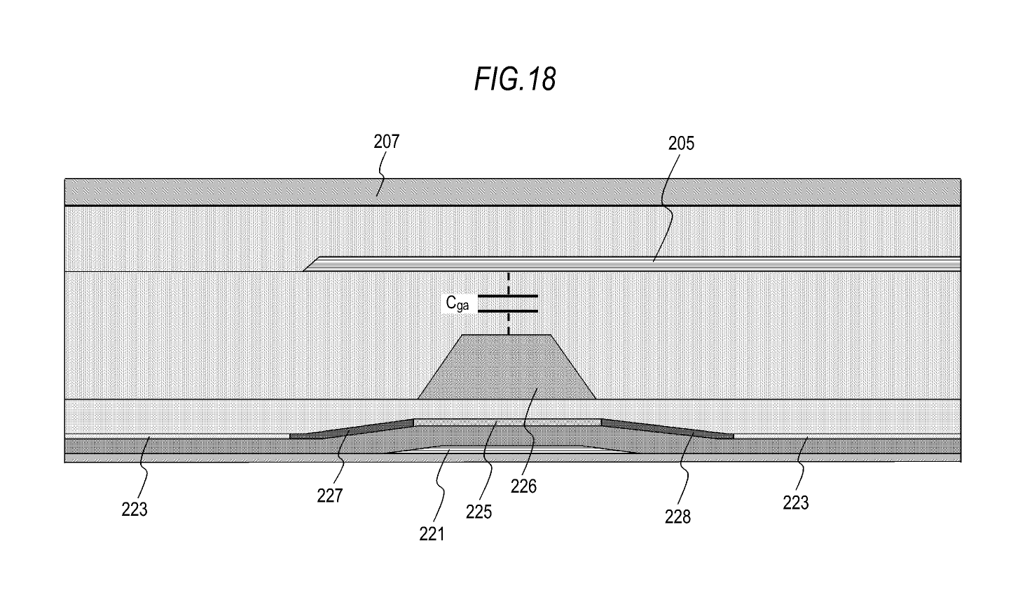

The pixel structure according to an example having the driving transistor 22 of the sandwich gate structure will be described using FIG. 18. FIG. 18 is a cross-sectional diagram illustrating a pixel structure according to an embodiment having a driving transistor 22 of a sandwich gate structure. In the drawing, the same reference numerals are used for the equivalent portions to those in FIG. 16.

The driving transistor 22 has the same sandwich gate structure as the case of the pixel structure according to the reference example as described above. That is, the driving transistor 22 has a structure in which the channel region 225 is sandwiched between the first gate electrode 221 arrange on the substrate side with respect to the channel region 225 and the second gate electrode 226 arranged on the opposite side as the back gate electrode. Also, the driving transistor 22 adopts an LDD structure in which low-density impurity regions having a density that is lower than that of the source/drain regions 223 and 224, that is, LDD regions 227 and 228, are provided between the channel region 225 and the source/drain regions 223 and 224.

On the other hand, in the organic EL device 21, the cathode electrode 207 is commonly wired with respect to all the pixels 20, and the anode electrode 205 is formed to be opposite to at least a portion of the back gate electrode 226, that is, to overlap at least a portion of the back gate electrode 226.

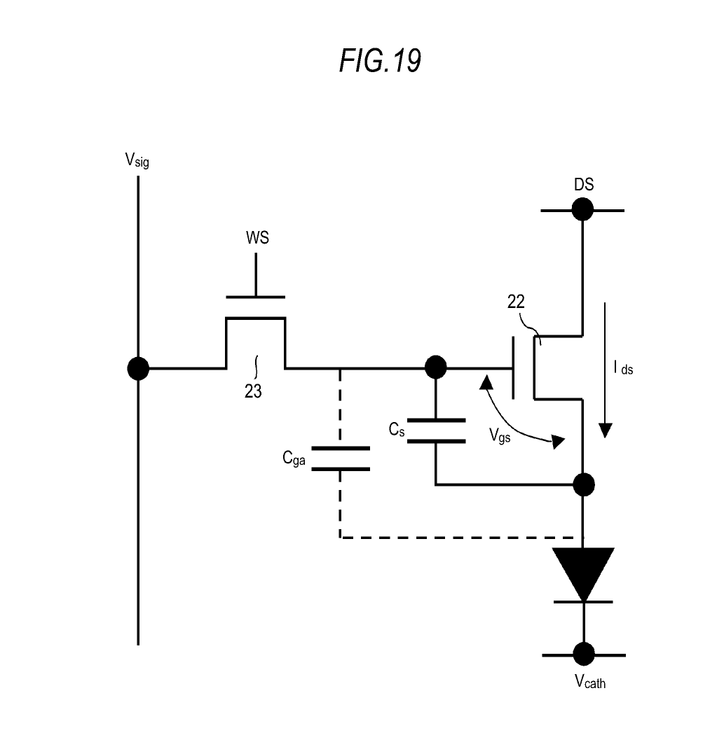

As the anode electrode 205 is opposite to at least a portion of the back gate electrode 226, a parasitic capacitance C_{ga} is formed between the opposite regions of the electrodes 205 and 226 between which the insulating layer is interposed as a dielectric material. This parasitic capacitance C_{ga} becomes the capacitance component interposed between the gate electrode of the driving transistor 22 and the cathode electrode of the organic EL device 21 as illustrated as the equivalent circuit in FIG. 19. In this case, the bootstrap gain G_{b} is given by the following equation (4).

G_{b}=(Cₛ+C_{gs}+C_{ga})/(Cₛ+C_{gs}+C_{gd}+C_{ws}) (4)

If the parasitic capacitance C_{ga} is formed between the anode electrode 205 and the back gate electrode 226, the parasitic capacitance C_{ga} is connected in parallel to the maintenance dos 24 (see FIG. 2) that is connected between the gate and the source of the driving transistor 22A. Accordingly, the parasitic capacitance C_{ga} acts in a direction in which the parasitic capacitance that is parasitic on the gate electrode of the driving transistor 22, particularly, the capacitance value between the gate and the source of the driving transistor 22, is reduced.

As the capacitance value between the gate and the source of the driving transistor 22 is reduced, as can be known from the equation (4), the bootstrap gain G_{b} is increased. Accordingly, by making the anode electrode 205 and at least a portion of the back gate electrode 226 opposite to each other, the capacitance value between the gate and the drain of the driving transistor 22 is reduced by the action of the parasitic capacitance C_{ga} that is formed between the opposite regions of the electrodes 205 and 226, and thus the bootstrap gain G_{b} is improved. As a result, a good-quality display image can be obtained without damaging the uniformity of the screen.

Here, from the view point that the capacitance value of the parasitic capacitance C_{ga} that is formed between the opposite regions of the anode electrode 205 and the back gate electrode 226 is greatly acquired, the anode electrode 205 may be formed to cover the upper surface of the back gate electrode 226. Also, in the pixel structure according to this example, the back gate electrode 226 is in the form of a trapezoid. Accordingly, from the view point of further greatly taking the capacitance value of the parasitic capacitance C_{ga}, as illustrated in FIG. 18, the anode electrode 205 is formed to cover the area that is larger than the bottom surface of the back gate electrode 226. Accordingly, a parasitic capacitance is slightly formed even between the inclined surface of the back gate electrode 226 and the anode electrode 205, and thus the capacitance value of the parasitic capacitance C_{ga} can be acquired more greatly.

The present application contains subject matter related to that disclosed in Japanese Priority Patent Application JP 2010-079015 filed in the Japan Patent Office on Mar. 30, 2010, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display device comprising:
a plurality of arranged pixels, each of which includes an electro-optical component, a write-in transistor writing an image signal in a pixel, a maintenance capacity maintaining the image signal written by the write-in transistor, and a driving transistor driving the electro-optical component based on the image signal maintained by the maintenance capacity;
wherein the driving transistor has a sandwich gate structure in which a channel region is sandwiched between two gate electrodes, and the electro-optical component is formed so that at least a portion of one of the two gate electrodes and an anode electrode are opposite to each other.

2. The display device according to claim 1, wherein the electro-optical component is formed so that the anode electrode is opposite to an upper surface of one of the gate electrodes.

3. The display device according to claim 2, wherein one of the gate electrodes has a trapezoid-shaped cross-section, and the electro-optical component is formed so that the anode electrode covers a region having an area that is larger than a bottom surface of one of the gate electrodes.

4. The display device according to claim 1, wherein the driving transistor has an impurity region having a density that is lower than that of a source/drain region between the channel region and the source/drain region.

5. The display device according to claim 1, wherein parasitic capacitance exists between the anode electrode and one of the two gate electrodes, and
the capacitance value of the parasitic capacitance becomes one parameter that determines a gain during a bootstrap operation in which a gate potential is changed to follow the source potential of the driving transistor when the write-in transistor is in a non-conductive state.

6. The display device according to claim 5, wherein the parasitic capacitance is connected in parallel to the maintenance capacity.

7. The display device according to claim 5, wherein the source potential of the driving transistor is changed according to a current flowing through the driving transistor.

8. An electronic appliance having a display device comprising:
a plurality of arranged pixels, each of which includes an electro-optical component, a write-in transistor writing an image signal in a pixel, a maintenance capacity maintaining the image signal written by the write-in transistor, and a driving transistor driving the electro-optical component based on the image signal maintained by the maintenance capacity;
wherein the driving transistor has a sandwich gate structure in which a channel region is sandwiched between two gate electrodes, and the electro-optical component is formed so that at least a portion of one of the two gate electrodes and an anode electrode are opposite to each other.
